(19) United States
(12) Patent Application Publication
(10) Pub. No.: US 2018/0001607 A1
(43) Pub. Date: Jan. 4, 2018

(54) POLYPROPYLENE FILM

(71) Applicant: The Procter & Gamble Company, Cincinnati, OH (US)

(72) Inventors: Lichao PAN, Beijing (CN); Zhan CHENG, Beijing (CN); Xu HUANG, Beijing (CN); Shuo SONG, Beijing (CN)

(21) Appl. No.: 15/641,005

(22) Filed: Jul. 3, 2017

(30) Foreign Application Priority Data
Jul. 1, 2016 (WO) CN2016/088053

(51) Int. Cl. B32B 27/30; C08F 10/06; C08G 77/42; G01N 23/201

(52) U.S. Cl. CPC B32B 27/30; C08G 77/42; C08F 10/06; G01N 23/201

(57) ABSTRACT

Certain films comprising polypropylene and silicone that are uniaxially stretched at stretching temperatures below 70° C. have desirable aesthetic effects.

### FIELD OF THE INVENTION

The present application is directed to certain polypropylene films, and methods of making the same.

### BACKGROUND OF THE INVENTION

Flexible thermoplastic films are used in a variety of applications including the construction of packaging and containers, protective films and coatings, and even wall paper. Typical thermoplastic polymers types include polyethylene (PE), polyethylene terephthalate (PET), and polypropylene (PP). In turn, PP is can be found in different grades such as homopolymer, random copolymer, and impact copolymer. Films can be blown or cast, and subsequently are typically stretched. Stretching can be in the machine direction, across the machine direction (i.e., traverse direction), or biaxially stretched. A low level of silicone may be added as slip agent, particularly in high temperature film stretching processes. Films may have one or more layers.

There is generally a need to provide visual aesthetics to PP films so products or packaging is more attractive to consumers or connotes higher quality. Examples of desirable aesthetic effects include pearlescent, metallic-like visual effects, increased opacity, and combinations thereof. Conventional approaches to providing these aesthetic effects to films include the use of metallic or pearlescent agents, or metallic or pearlescent inks. However, these ingredients are generally expensive and thus are cost prohibitive in many applications.

One way to characterize these pearlescent and/or metallic-like aesthetic effects from films is by way of a Flop Index. Briefly, Flop Index is the measurement on the change in reflectance of a color as it is rotated through the range of viewing angles. A flop index of 0 indicates a solid color, while a very high metallic or pearlescent color may have a flop index of 15. There is a need to provide PP films that have desirable aesthetic effects without, or at least minimizing, the use of expensive pearlescent/metallic agents or pearlescent/metallic inks, while preferably being cost effective.

Another example of desirable aesthetic effects is opacity. In some applications, film opacity connotes quality. One conventional way of providing opacity to films is the use of opacifiers such as titanium dioxide. However, there are potential drawbacks to using titanium dioxide. The ingredient is generally expensive for many applications. Moreover, it has been reported that higher levels of titanium dioxide in some films may reduce sealing performance in subsequent forming or packing processes. Furthermore, high titanium dioxide loading levels tend to have titanium dioxide distribution problem in some films, in which the titanium dioxide particles forms gel in film and cause so called “fish eye” defects in film. Yet further, this defect may bring in further defects in printing thereby harming the overall aesthetics of printed film. One way to characterize opacity is by ISO method 6504. There is a need to provide PP films that have improved opacity without, or at least minimizing, the use of opacifiers (such as titanium dioxide), while preferably exhibiting desired film aesthetic effects (and doing so cost effectively).

Accordingly, there is a need to provide a PP film that provides desirable aesthetic properties, while more preferably eliminating, or at least minimizing, the use of expensive and/or performance inhibiting ingredients.

### SUMMARY OF THE INVENTION

The present invention meets one or more of these needs based on the surprising discovery that by blending a PP and a relatively high level of silicone in a film formulation, preferably where the silicone and PP in the subject film layer are stretched at a relatively low stretching temperatures, provides a film exhibiting desirable aesthetics effects. Preferably the film has at least one layer, wherein the one layer comprises from 80% to 99% of a PP polymer by weight of the one layer and from 1% to 10% of a silicone by weight of the one layer. Preferably these inventive films are made by stretching at lower relative stretching temperatures (as compared to conventional stretching temperatures) for example below 70° C., or even below 50° C.

Without wishing to be bound by theory, the relatively low stretching temperature is responsible for achieving the desired microstructure that provides the desired aesthetic effects. Importantly, the relatively high level of silicone enables the PP-based film to have a relatively high elongation percentage under relatively low stretching temperatures by minimizing film breakage. In contrast, analogous PP-based film, without any silicone, generally breaks at these higher elongation percentages at these relatively lower stretching temperatures. Elongation percentage is one way of measuring the degree of stretching (during the film conversion process). In other words, the desired lamella microstructure cannot be achieved without silicone due to inadequate elongation before film breakage. One way of characterizing the desired microstructure of the inventive films is by Wide-Angle X-ray Diffraction (WAXD) and/or Small-Angle X-ray Scattering (SAXS). Specifically, the subject film layer of the present invention has less than 95% crystallinity with strong orientation as determined by WAXD. The relatively lower crystallinity would seem to indicate the formation of lamellae and/or fibril and amorphous structure from the rearrangement of spherulites. In addition, or alternatively, the subject film layer of the present invention has the presence of the equatorial streak as determined by SAXS. Without wishing to be bound by theory, the equatorial streak is likely attributed to the formation or oriented structures (shish) parallel to the machine direction during stretching. This suggests the stretching temperature is low enough to form the desired lamella during the orientation process without much recrystallization induced by the stretching temperature (during film conversion). As a result, such films have more desirable aesthetic effects. In non-limiting examples, these aesthetics may be measured by opacity, Flop Index (FI), Dynamic Luminosity (DL), or combinations thereof.

It is an advantage of these films to provide desirable aesthetic effects while minimizing, preferably omitting, the use of pearlescent/metallic agents and/or pearlescent/metallic inks.

It is an advantage of the film to have greater opacity than conventional films.

It is an advantage of the film to minimize the use of material and/or thickness while providing relatively high levels of opacity.

It is an advantage of the films to having relatively high levels of opacity while minimizing the amount of opacifiers (such as titanium dioxide).

One aspect of the invention provides for a film comprising at least one layer, wherein the least one layer comprises: a) 80% to 99%, by weight of the at least one layer, of at least one polypropylene (PP) polymer of a PP component; b) 1% to 20%, by weight of the at least one layer, of at least one silicone of a silicone component; c) 0% to 15%, by weight of the at least one layer, of an optional ingredient; and wherein the at least one layer has a percentage of crystallinity of less than 95% as determined by Wide-Angle X-ray Diffraction (WAXD). Preferably the film wherein the at least one layer has a presence of an equatorial streak as determined by Small-Angle X-ray Scattering (SAXS). Preferably the film, wherein the at least one layer is characterized by at least one of the following, preferably at least two of the following, preferably by all of the following: Flop Index (FI) is greater than 1.6; opacity is greater than 10%, and Dynamic Luminosity (DL) is greater than 49.

Another aspect of the invention provides for a for a film comprising at least one layer, wherein the least one layer comprises: a) 80% to 99%, by weight of the at least one layer, of at least one polypropylene (PP) polymer of a PP component; b) 1% to 20%, by weight of the at least one layer, of at least one silicone of a silicone component; c) 0% to 15%, by weight of the at least one layer, of an optional ingredient; and wherein the at least one layer has a presence of an equatorial streak as determined by Small-Angle X-ray Scattering (SAXS).

Another aspect of the invention provides for a method of making an aforementioned film, comprising the step of stretching at temperature below 70° C., and preferably wherein the uniaxial elongation percentage is at least 200%.

These and other features, aspects and advantages of specific embodiments will become evident to those skilled in the art from a reading of the present disclosure.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, and in which:

FIGS. 1a and 1b is a table of films samples numbering from 1 to 27 detailing the composition, film making conditions, and relevant data. The subject table makes reference to FIGS. 2a to 28a; 2b to 28b, 2c to 28c, and 2d to 28d.

FIGS. 2a to 28a are WAXD pattern data.

FIGS. 2b to 28b are WAXD profile data;

FIGS. 2c to 28c are SAXS pattern data; and

FIGS. 2d to 28d are SAXS profile data.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The present invention is generally directed to a silicone and PP blended film and stretching the film at relatively low temperatures (i.e., relatively low stretching temperatures), to provide films exhibiting desired aesthetic effects (without breakage). It is this relatively lower stretching temperature that provides films having microstructure that provides the desired aesthetic effects. These aesthetic effects may be assessed by one or more of the following analytical techniques: Flop Index according to ASTM E2539; opacity at a defined thickness per ISO 6504, and Dynamic Luminosity (DL) as described herein.

The term “film” is used broadly to include those films having at least one, or two, or more layers. For example, a two layer co-extrusion film may have a first layer according the invention described herein while the second layer is a conventional one. Preferably the film is a flexible film. The films of the present invention may be extrusion blown or extrusion cast, preferably are uniaxially oriented in either the machine direction or traverse direction (but can also be biaxially oriented). In multi-layer films of the present invention, other layers of the film may contain PE, PP, PET, EVOH, tie polymers, elastomers or combinations thereof. Yet other layers of the multi-layer film may contain PP without silicone. Yet other films of the present invention contain only PP as the thermoplastic polymer as to improve recyclability of the films (i.e., the films or free or substantially free of PE or PET). The multi-layer films of the present invention may be laminated or co-extruded.

Polypropylene (“PP”)

At least one layer of the films of the present invention comprises polypropylene (PP) as a principle thermoplastic polymer (i.e., a PP-based film). In other words, at least one layer of the film comprises a PP component. In turn, the PP component may comprise one or more grades of PP polymers. PP typically has a density between 0.895 g/cm³ and 0.920 g/cm³. The melt flow rate (at 230° C./2.16 Kg (“MFR”)) is preferably from 0.1 g to 70 g/10 minutes, preferably 1 g to 10 g/10 minutes. Preferably the highest Isotactic Index is at or below 98%. There are three general types of PP polymer: homopolymer, random copolymer, and block copolymer. The comonomer is typically used with ethylene or butylene. Ethylene-propylene rubber is added to polypropylene homopolymer increases its low temperature impact strength. Randomly polymerized ethylene monomer added to polypropylene homopolymer decreases the polymer crystallinity, lowering the melting point and makes the polymer more transparent. Suitable suppliers/products for PP may include Sinopec Chemicals. Suitable suppliers for silicone may include Dow Corning.

At least one layer of the film comprises from 80% to 99%, by weight of the at least one layer of the film of a PP component. Preferably the at least one layer of the film comprises from 90% to 99%, preferably 94% to 98.5%, alternatively from 95% to 97.5%, by weight of the at least one layer, of the PP component. The PP component has at least one PP polymer, optionally two or more PP polymers (i.e., different grades of PP). At least one layer of the film comprises from 80% to 99%, by weight of the at least one layer, of at least one PP polymer of the PP component. Preferably the at least one layer of film comprises from 90% to 99%, preferably from 94% to 98.5%, alternatively from 95% to 97.5%, by weight of the at least one layer, of the at least one PP polymer of the PP component.

Preferably the at least one film layer comprises from 1% to 100% by weight of the PP component, of a homo-polymer PP or random copolymer PP or combination thereof. Preferably the one film layer comprises 100% by weight of the PP component of either a homo-polymer PP or a PP random copolymer.

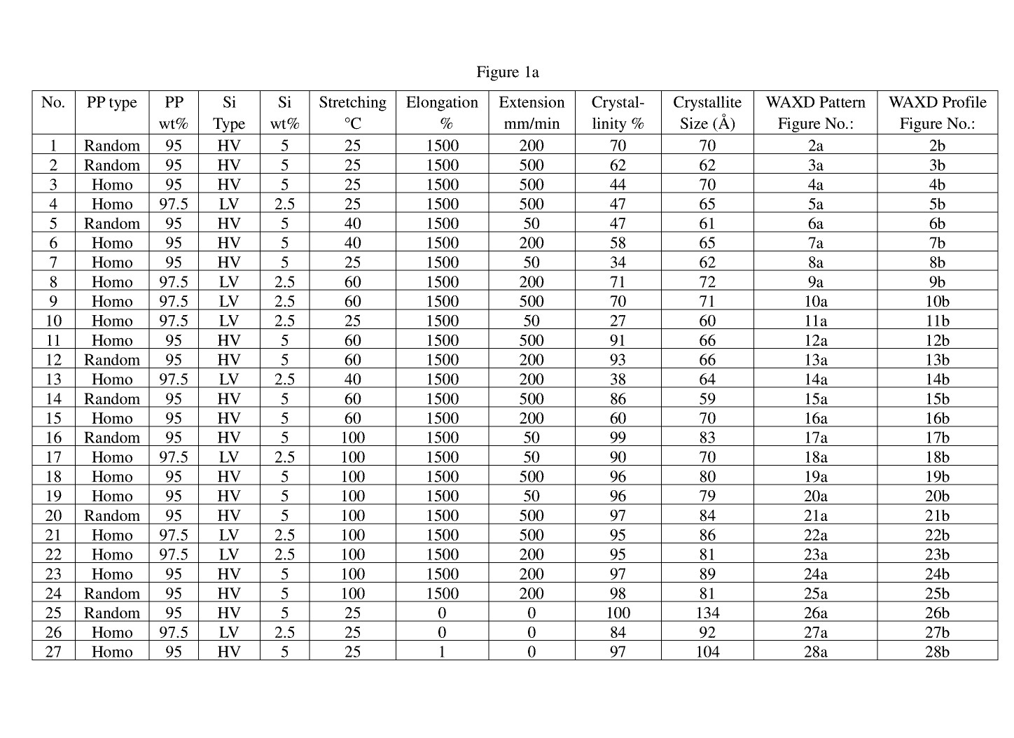

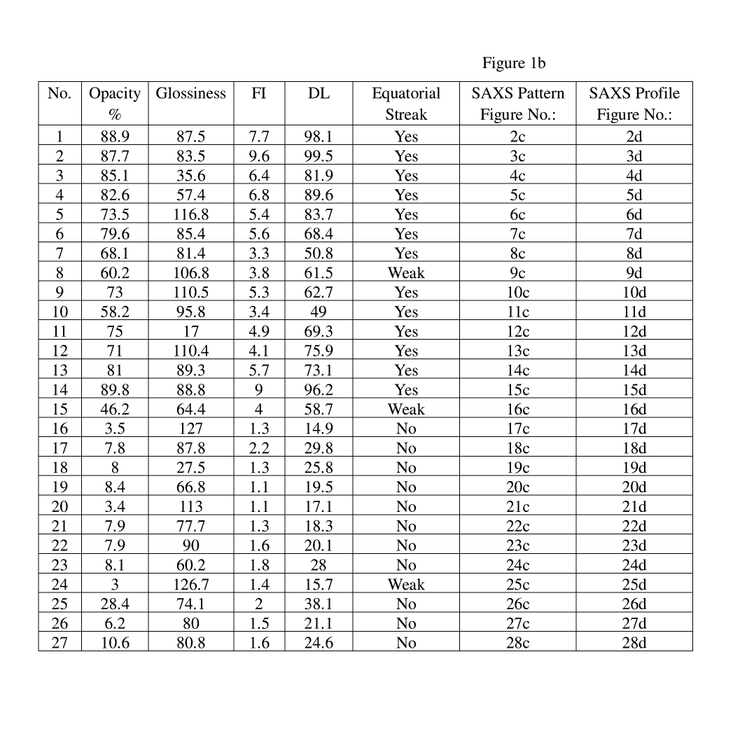

One example of a PP grade is a homopolymer PP. Preferably the homopolymer PP comprises a Melt Flow Rate (230° C./2.16 Kg)(“MFR”) from 2.6 to 3.0 g/10 min, preferably 2.7 to 2.9 g/10 min, more preferably about 2.8 g/10 min. Preferably the homopolymer PP comprises a Tensile Strength at Yield of 26 to 36 MPa, preferably 28 to 35 MPa, more preferably at or greater than about 30 MPa. Preferably the homopolymer PP comprises an Isotactic Index at or greater than 93%, more preferably at or greater than 94%, yet more preferably at or greater than 95%, alternatively at or less than 98%. One preferred example of a homopolymer PP is PPH-F03D from Sinopec, having a MFR of 2.8 g/10 min, Tensile Strength at Yield at greater than 30 MPa, and an Isotactic Index at or greater than 95%. This example is identified as “Homo PP type” in the table of FIGS. 1a and 1b.

One example of a PP grade is a random copolymer PP (RCPP). Preferably the RCPP comprises a Melt Flow Rate (230° C./2.16 Kg)(“MFR”) from 2.6 to 3.0 g/10 min, preferably 2.7 to 2.9 g/10 min, more preferably 2.8 g/10 min. Preferably the random copolymer PP comprises a Tensile Strength at Yield of 27 to 37 MPa, preferably 29 to 36 MPa, more preferably at or greater than 31 MPa. Preferably the random copolymer PP comprises an Isotactic Index at or greater than 96%, more preferably at or greater than 97%, yet more preferably at or greater than 98%. One preferred example of a RCPP is F280M from Sinopec, having a MFR of 2.8 g/10 min, Tensile Strength at Yield at greater than 31 MPa, and an Isotactic Index at no more than 98%. This example is identified as “Random PP type” is the table of FIGS. 1a and 1b.

Silicone Component

At least one layer of the film of the present invention comprises silicone. In other words, at least one layer of the film comprises a silicone component. The films comprise at least one layer comprising from 1% to 20%, by weight of the at least one layer, of at least one silicone of a silicone component. Preferably the at least one layer comprises from 1% to 10%, preferably from 1.5% to 7%, more preferably from 2% to 6%, alternatively from 2.5% to 5% of the silicone by weight of the least one layer. The silicone component has at least one silicone, optionally two or more silicones (e.g., the silicone may be of a different type and/or molecular weight). Without wishing to be bound by theory, silicone component facilitates low temperature (i.e., below 70° C.) stretching. The silicone component can be added: via a master batch; at a film extrusion stage in which the silicone component is directly blended with other ingredients; or a combination thereof.

Many silicone types are contemplated within the scope of the invention. The silicone, of the silicone component, is preferably a silicone fluid, more preferably a silicone oil. Preferred silicones include linear or branched silicone fluids and cyclic silicone fluid and combinations thereof. Although not preferred, the following silicones may also be used: gums, resins, gels, rubber, elastomers, solid silicones, and combination thereof. The molecular structure is another way of characterizing the silicone of the present invention. Both cyclic and linear silicones, and combinations thereof, are within the scope of the invention. Organic functionality is another parameter in defining the silicone of the present invention. Within the scope of the present invention these organic functionalities may include alkyl, preferably C₁ to C₅ alkyl, ethyl, methyl, dimethyl polyether, amino, and combinations thereof.

Kinematic viscosity is one way of characterizing the molecular weight of the silicone. Preferably, the silicone additive may have a kinematic viscosity of at least 500 centistokes (cSt), more preferably at least 750 cSt, yet more preferably at least 1000 cSt. Preferably the viscosity is from 500 cSt to 40,000,000 cSt, more preferably from 1000 cSt to 20,000,000 cSt.

One example of a silicone is a linear dimethicone having a viscosity below 600,000 cSt, preferably from 1,000 cSt to 600,000 cSt.

In another example, the silicone is an ultra-high molecular weight silicone (e.g., Dow Corning). The silicone additive is high molecular weight having a molecular weight from 400,000 Dalton to 700,000 Daltons, preferably from 500,000 Daltons to 650,000 Daltons. The silicone additive can also be provided by way of a master-batch (e.g., in a PE matrix). “MB 50-002” from Dow Corning is a suitable example, having a molecular weight of about 600,000 Daltons; and an overall viscosity of about 40,000,000 cSt.

Methods of measuring kinematic viscosity of silicones are described. On approach is using a glass capillary viscometer per method ASTM D-445, IP 71 with results reported in Stokes (St). Briefly, the kinematic viscosity of liquids is determined by measuring the time required for a fixed volume of samples to pass through a calibrated glass capillary. For those silicones having a viscosity generally greater than 12,500 cSt, viscosity can be assessed by a pressure viscometer at designated shear rates per the procedure of ASTM D 1092. Briefly, the sample is forced through a calibrated capillary. The equilibrium pressure is determined and used to calculate the viscosity. The shear rate is a function of the radius of the capillary and volume flow per unit of time.

Without wishing to be bound by theory, the higher the viscosity of the silicone, generally the better since higher viscosity silicone, as far as in fluid form, gives better processing feasibility than lower viscosity silicone.

The least one silicone (of the silicone component) is a siloxane fluid, preferably the siloxane fluid is a linear or branched polymer or copolymer, more preferably the siloxane fluid is selected from polydimethylsiloxane homopolymers, copolymers consisting essentially of dimethylsiloxane units and methylphenylsiloxane units, copolymers consisting essentially of diphenylsiloxane units and methylphenylsiloxane units, and combinations thereof, alternatively the siloxane fluid is a silicone elastomer.

Examples siloxane fluid may include polydialkylsiloxanes, polyalkylphenylsiloxanes, olefin-modified siloxane oils, olefin/-polyether-modified silicone oils, epoxy modified silicone oils, alcohol-modified silicone oils, polydialkylsiloxanes (which preferably has from 1 to 5, more preferably 1 to 4, carbon atoms in the alkyl group, yet more preferably the polydialkylsiloxane is polydimethylsiloxane). One suitable supplier of such silicone may include Dow Corning.

Optional Ingredient

The films may contain optional ingredients. Preferably the at least one layer of the film comprises from 0% to 15%, by weight of the at least one layer, of an optional ingredient; more preferably from 1% to 12%, yet more preferably 2% to 10%, alternatively from 0% to less than 5%, alternatively from 0% to less than 3%, by weight of the at least one layer, of the optional ingredient. The optional ingredient, if present, preferably comprises an opacifier, ultraviolet light protective agent, elastomer, and the like.

Opacifier

It is an advantage of some of the inventive films herein to have more opacity than comparable conventional films thereby minimizing the amount of opacifier (such as titanium dioxide). Accordingly less opacifier can be used in the present films, as compared to other conventional films, thereby saving money on costs associated with opacifier as well as potentially improving film mechanical properties that are sometimes negatively associated with higher levels of opacifier. Generally, opacity is a measure of the capacity of a material to obscure the background behind it. Opacity measurements are sensitive to material thickness and degree of pigmentation or level of opacifier (e.g. titanium dioxide (TiO₂) particles). The opacity value is shown as a percentage between 1% and 100%. The value for opacity is obtained by dividing the reflectance obtained with a black backing (RB) for the material, by the reflectance obtained for the same material with a white background (RW). This is called the contrast ratio (CR) method % Opacity=RB/RW×100. Suitable methods to measure opacity include ISO 6504.

Other opacifiers may include CaCO₃, Carbon black, ZnO₂, BaSO₄, and organic dye. In some applications, titanium dioxide is preferred where the films are desired to have a white appearance. One skilled in the art will readily identify other opacifiers by selecting those materials that have a refractive index substantially different than the rest of the film layer. Many of films described herein provide greater opacity (potentially as well as other desired aesthetic effects) that cannot otherwise be provided by many conventional films (of comparable or lower thickness etc.). In those applications, where increased opacity is desirable, the present films may provide enough opacity without expensive opacifiers or at least minimizing the use of such opacifiers (such as titanium dioxide (TiO₂)). Even those films where significant opacity is needed, a lesser amount of opacifier may be used. Typically, the present invention may comprise from 0% to 10%, preferably from 1% to 5% by weight of at least the one layer of the film, of the opacifier is included.

In some applications, the film of the present invention may have opacity of greater than 60%, preferably greater than 70%, more preferably greater than 75%, at a film thickness at or below 50 microns per ISO 6504. Preferably the film contains from 0% to less than 5%, preferably less than 4%, more preferably less than 3%, by weight of the at least one layer of the film, of an opacifier, preferably wherein the opacifier is titanium dioxide.

Master Batch

A master batch comprising: PP and silicone; and optionally optional ingredients, is prepared. Typically the master batch comprises from 50% to 95%, preferably 60% to 90% of a PP component, of the master batch, of a PP component. The master batch typically comprises from 5% to 20%, preferably from 10% to 20% of, alternatively from 12% to 18%, alternatively about 15%, by weight of the master batch, of a silicone additive. Of course the master batch may comprise optional ingredients, preferably from 0% to 10% by weight of the master batch.

The master batch may be prepared by heat extruding a first batch of PP pellets with a first heat extruder, either single or double screw, wherein the PP and silicone are added at one more ports along the extruder. Typical operating temperatures for the first heat extruder are from 180° to 250° Celsius (C), preferably 190° to 230° C. Preferably the heat temperature range of the first heat extruder is at whatever is recommended by the manufacturer of the PP pellets (e.g., depending upon polymer grade etc.). Generally, many silicones can be processed at PP processing temperature ranges. For purposes of clarification, the term “pellets” means smaller sized nuggets, pastilles, or the like to allow for efficient melting and/or extrusion and/or blending.

Extrusion

The master batch may be combined with a second batch of PP pellets in a desired weight ratio. The second batch of PP pellets may or may not be the same composition as the first batch of PP pellets (as detailed above in master batch preparation). The combination of master batch and second batch of PP pellets may be subjected to a blending step to provide a blend.

The resulting blend is extruded through a second heated extruder, either single or double screw, preferably through an extruder having a temperature gradient to form an extrudate. Initial temperatures of the second heated extruder, for example, may be at 200° C. incrementally increased downstream to a final temperature of 250° C. Of course these temperatures may vary depending upon the composition of the resulting blend, and length/speed of the second heated extruder etc. An optional step is adding yet more silicone and/or optional ingredients through one or more ports of the second heated extruder to yet further increase the overall silicone or optional ingredient concentration. Alternatively, no master batch is prepared, but rather silicone or optional ingredient is simply added via the second heated extruder with only a single batch of PP pellets extruded there through.

The extrudate is formed after being extruded through the second heated extruder. The extrudate is then subjected to a blowing step or a casting step. The typical blowing step is to extrude the extrudate upward via a ring die to form a tube, and inflate the tube while pulling it through a collapsing frame whereby the tube is enclosed with a frame and nip rollers. The blowing step can also be a water quenching process, in which the inflated tube is extruded downward through a ring die with another water ring to spray water on the tube surface to quench it. A casting step subjects the extrudate though a T-die to form a flat sheet with an air knife to push the flat sheet against a cooling roller to set the film. These steps are generally conventional. The blown and/or casted extrudate is formed into an unconverted film. The unconverted film typically has hazy appearance and it requires additional orientation process to impart the desired desirable aesthetic effects.

Machine Direction Orientation

The unconverted film is thereafter at least uniaxially oriented, either in the machine direction (“MD”) or across the MD direction (i.e., transverse direction (“TD”)). Preferably the film is not biaxially oriented (i.e., preferably not in the both the MD and TD directions). The MD direction is also known as the longitudinal direction (generally perpendicular to the TD). MD orientating is a preferred initial step after the unconverted film is formed. During the MD orientation, the unconverted film from the blown or casted line is heated to a stretching temperature via one or multiple hot rollers. The heated film is fed into a slow draw roll with a nip roller, which has the same rolling speed as the heating rollers. The film then enters a fast draw roll. The fast draw roll has a speed that is 2 to 10 times faster than the slow draw roll, which effectively stretches the film on a continuous basis. There can be another fast draw roll which is even faster than the first fast draw roll so that the film is subjected to two step stretching. Between the two stretching steps there is another set of heating rolls which sets the temperature of the film after the first stretching and before the second stretching. The temperatures in these two stretching steps can be the same or different. The orientation can also be a single stretching instead of two step stretching.

An important aspect of the process of making the film of the present invention is the stretching temperature. This stretching temperature applies to either the MD or TD stretching. The step of stretching is at a temperature below 70° C., preferably below 60° C., more preferably below 50° C., yet more preferably below 40° C., yet still more preferably below 30° C., alternatively from 20° C. to 65° C., alternatively from 20° C. to below 70° C., alternatively combinations thereof.

The degree of stretching (under this above-identified stretching temperature ranges) can be characterized by a elongation percentage is at least 200% preferably at least 300%, more preferably at least 400%, preferably at least 500%, alternatively at least 1000%, alternatively from at least 200% to less than 2,000%, alternatively from at least 200% to 1500%, alternatively from 200% to 500%, alternatively combinations thereof. These elongation percentage ranges apply to either MD or TD stretching.

Without wishing to be bound by theory, the desirable microstructure that provides the aesthetic effects is achieved by the relatively low temperature stretching. In turn, the silicone facilitates stretching at the low temperatures (e.g., to help against film breakage during stretching) to allow the films to obtain the indicated elongation percentages.

Turning to MD orientation, optionally, the stretched film then enters annealing thermal rollers, which allow stress relaxation by holding the film at an elevated temperature for a period of time. Annealing generally makes the film less stiff and softer to the touch, which are desired tactile effects for a film in some applications. To achieve such annealing, the annealing temperature should not be below the stretching temperature, and more preferably the annealing temperature is 5-10° C. above the stretching temperature. But in either case, the annealing temperature is generally not expected to exceed 110-120° C., because as at such temperatures, the desirable aesthetic effects of the film can be harmed. As a last step, the film is cooled through cooling rollers to an ambient temperature. The resulting MD oriented film may be further subjected to either: optional surface treatment steps/optional coatings. In contrast, a shrink film will preferably not have annealing or be at annealing temperature much lower than orientation temperatures.

A typical thickness of the MD oriented film, i.e., overall film, is from 15 microns to 80 microns, preferably from 20 microns to 70 microns, more preferably from 40 microns to 60 microns, alternatively from 20 microns to 50 microns, alternatively combinations thereof. Within these MD oriented films, at least one (or more) of the inventive layers may have a thickness of 20 to 60 microns.

Traverse Direction (TD) Orientation

In an alternative to MD orientation, the unconverted film is subject to TD orientation. One way of conducting TD orientation is using a tenter frame, preferably also using a plurality of tenter clips that orient the film in a non-machine direction, more preferably wherein the non-machine direction is perpendicular to the machine direction. Briefly, the tenter clips clip peripheral edge of the film and pull the film toward the frame of the tenter frame (i.e., the non-machine direction). The stretching temperature range as well as the elongation percentage for the TD orientation process is generally the same as what is desired for MD orientation.

A typical thickness of the TD oriented films is from 15 microns to 80 microns, preferably from 20 microns to 70 microns, more preferably from 40 microns to 60 microns, alternatively from 20 microns to 50 microns, alternatively combinations thereof. Within these TD oriented films, one or more of the inventive layer have a thickness of 20 to 60 microns.

Commercial available converting systems may include those from DUSENBERY, MARSHALL and WILLIAMS, winders may come from and PARKSINSON. Drive and control systems for film making may include those from ALLEN-BRADLEY Powerflex AC drives, and ALLEN-BRADLEY ControlLogix PLC processor. A suitable manufacture may be PARKINSON TECHNOLOGIES, Inc. (Woonsocket, R.I., USA).

Optional Surface Treatment Steps

The MD or TD films of the present invention are optionally subjected to one or more surface treatment steps. Surface treatment increases the surface energy of the film to render the film receptive to coatings, printing inks, and/or lamination. Preferred methods include corona discharge, flame treatment, plasma treatment, chemical treatment, or treatment by means of a polarized flame. In a preferred embodiment, one or both of the outermost surfaces of the inventive film is surface treated.

In the case of corona treatment, an advantageous procedure is to pass the film between two conductor elements serving as electrodes, such a high voltage, usually an alternating voltage (from about 5 to 20 kV and from about 5 to 30 kHz), being applied between the electrodes that spray or corono discharges can occur. The spray or corona discharge ionizes the air above the film surface, which reacts with the molecules of the film surface, causing formation of polar inclusions in the essentially non-polar polymer matrix.

For flame treatment with polarized flame, a direct electric voltage is applied between a burner (negative pole) and a chill roll. The level of the applied voltage is between 400 V and 3,000 V, preferably in the range from 500 V to 2,000 V.

Measurement of Desirable Aesthetic Effects

One way of characterizing the desirable aesthetic effects, is from the angle dependent light reflection (or “glossiness”) and color luminosity (or “L”). A non-flat satin surface provides different angles to certain incident light and thus the reflected light provides different glossiness and L in different areas of the surface. This difference in glossiness and reflection can be measured by at least one of two the methods described below:

Firstly, Flop Index or “FI” is the characterization of color luminosity change, and can be mathematically calculated by the following formula:

$$Flop Index = \frac{2.69 {( {L}_{15 °}^{*} - {L}_{110 °}^{*} )}^{1.11}}{{( {L}_{45 °}^{*} )}^{0.86}} ;$$

wherein an incident light that is 45° to the surface, and the mirror reflection direction is symmetrically on the other side of the normal line which is perpendicular to the surface. L*_{15°} describes the luminosity at the angle which is 15° to the normal line from the reflection direction, and L*_{110°} is 110° to the normal line from the reflection direction. L*_{45°} is the normal line which is perpendicular to the surface. Flop Index indicates the L changes with different observation angles and higher FI means more dark and light contrast and thus more evident effect. FI can be measured following ASTM E2539. A suitable measuring device includes a multi angle photometer MA98 from X-rite Company.

One aspect of the invention provides for a film having a least one layer, wherein the one layer comprises a Flop Index (FI) greater than 1.6, preferably at or greater than 3.3, more preferably greater than 3.8, yet more preferably greater than 5, yet still more preferably greater than 6, yet still even more preferably greater than 6.4, alternatively from 3.5 to 12, alternatively from 4 to 11, alternatively from 6.4 to 6.8. Preferably the FI is measured according to ASTM E2539.

Dynamic Luminosity or DL

Luminosity is a measurement of how light or dark a color is. Luminosity is also generally referred to as “lightness” or “brightness.” Luminosity is one of the coordinates in the CIE L*a*b color spectrum. CIE L*a*b* (CIELAB) is a color space specified by the International Commission on Illumination (French Commission internationale de l′éclairage, hence its CIE initialism). It describes all the colors visible to the human eye and was created to serve as a device-independent model to be used as a reference. Luminosity represents the lightness of the color with L*=0 yields black and L*=100 indicates diffuse white and specular white may be higher.

One important characteristic of the aesthetic effects, as provided in the present invention, is the luminosity change characterized between different observing angles. This luminosity change, regardless of color, provides for a dynamic effect. The higher the contrast, over wider observation angle range, results in an increased dynamic effect thereby making for a more desirable aesthetic effect. Dynamic luminosity or “DL” is a measurement of the luminosity changes between two specific angles that are perpendicular to each other. It is defined as L(−15)-L(75). In case of specular reflection, both incoming light (the incident ray) and outgoing light reflected (the reflected ray) are 45° with respect to the surface normal. “L(−15)” describes the luminosity at the angle which is 15° to the surface from the outgoing light, and “L(75)” is 75° to the normal line from the outgoing light. Suitable measuring device includes multi angle photometer MA98 from X-rite Company. See ASTM E2539

One aspect of the invention provides for a film having at least one layer, wherein the one layer comprises a Dynamic Luminosity (DL) value greater than 49, preferably greater than 50, more preferably from greater than 60, yet more preferably greater than 70, yet still more preferably greater than 80, alternatively from 50 to 110, alternatively from 80 to 100, alternatively from 82 to 99.

In addition to desirable aesthetic effects of the films herein, there may also be tactile benefits. For example, roughness is the character of flat surface profile affecting both visual effects and tactile effects of the subject films. Suitable methods of measuring roughness include ISO 4287:1997. Coefficient of Friction (“COF”) is the character of how a film frictions to other contact surfaces under pressure. COF relates to how a film feels, especially the smoothness by touching. A suitable method of measuring COF of a film includes ISO 8295. Hardness is the character of how hard a surface is and it directly affects how a surface feels. A suitable method of measuring film hardness includes ASTM D3363-05. Of course consumer testing (qualitative or quantitative) can also be conducted to characterize these films.

WAXD/SAXS

One way of characterizing the microstructure of the inventive film is by Small-Angle X-ray Scattering (SAXS) and/or Wide-Angle X-ray Diffraction (WAXD). Specifically, the at least one layer of the film of the present invention has less than 95% crystallinity as determined by WAXS. Preferably, the least one layer of the film has a presence of an equatorial streak as determined by Small-Angle X-ray Scattering (SAXS).

The synchrotron WAXD/SAXS measurements are carried out at BL16B beam line in the Shanghai Synchrotron Radiation Facility (SSRF), Shanghai, China. The X-ray wavelength of the synchrotron radiation is 0.124 nm. A Mar165 CCD detector is employed to collect two dimensional (2D) patterns, having a resolution of 2048×2048 pixels with pixel size of 80 μm. The sample-to-detector distance is 84 mm and 1810 mm from the sample for WAXD and SAXS experiment respectively. An air scattering pattern, at room temperature of 23° C. with no film sample on the sample stage, is also collected and used for background correction of the WAXD/SAXS. Analysis of the X-ray data is carried out using the corrected WAXD/SAXS patterns. The 2D scattering images of WAXD are analyzed with Fit2D software from the European Synchrotron Radiation Facility (ESRF). The following procedure is adopted to calculate the total crystalline fraction of the PP film. A radial average is performed on the 2-D WAXS pattern, which provides a quantitative WAXS spectrum with intensity versus 2. From the iterative peak-fit procedure, the percent area of each peak (corresponding to mass fraction of each reflection) and of the amorphous background curve are extracted. The percent amorphous phase in the polymer bulk is calculated from the area percentage of the amorphous background curve. The percent total crystalline phase in the PP is then obtained (100-% amorphous).

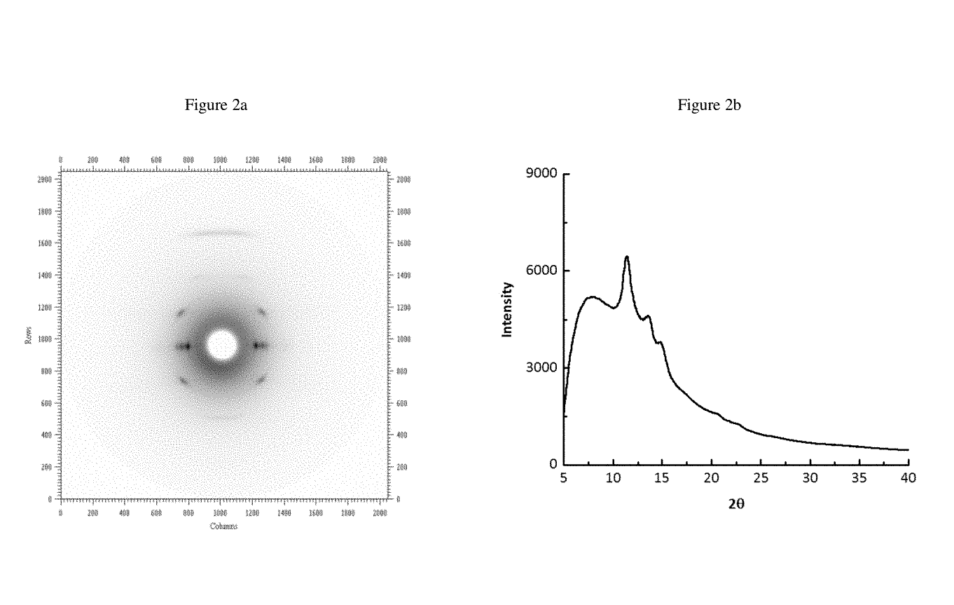

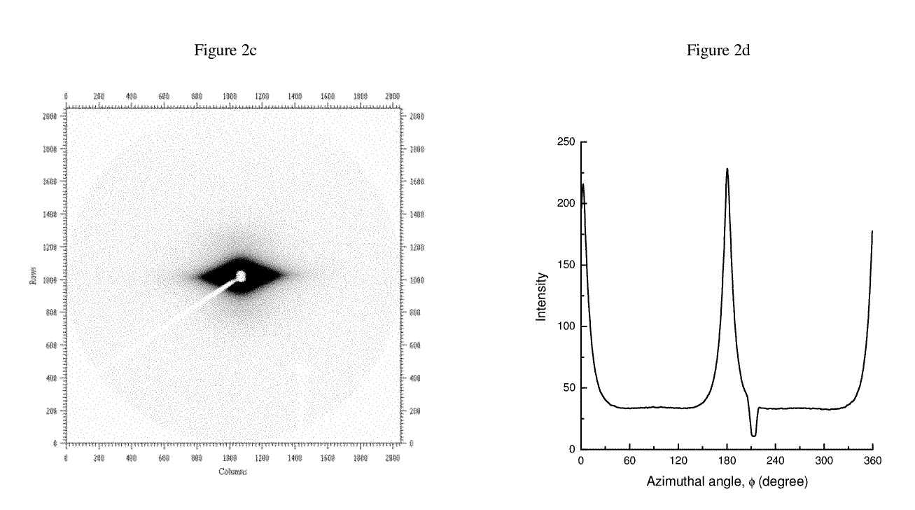

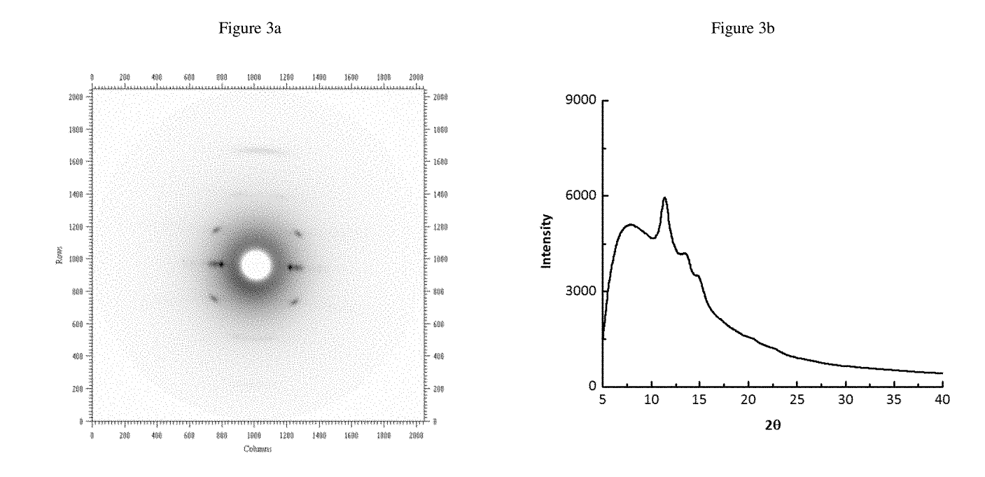

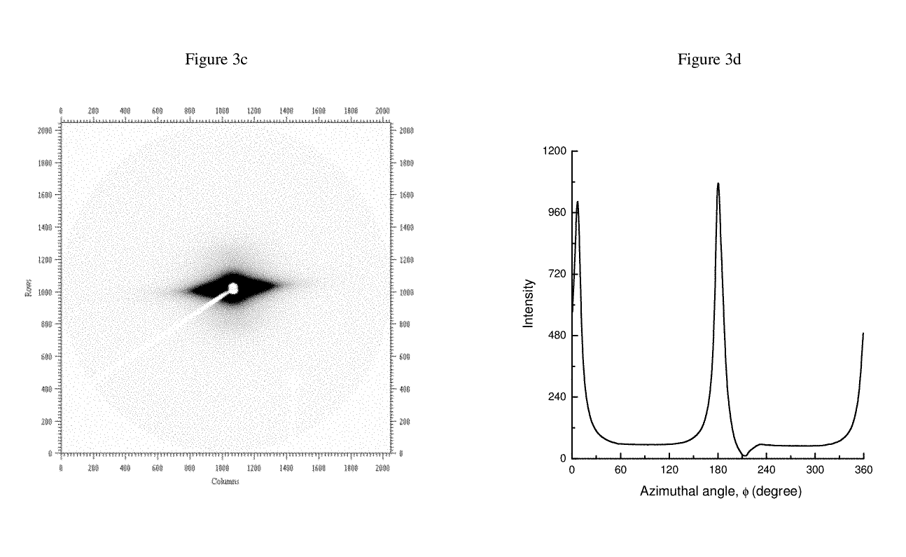

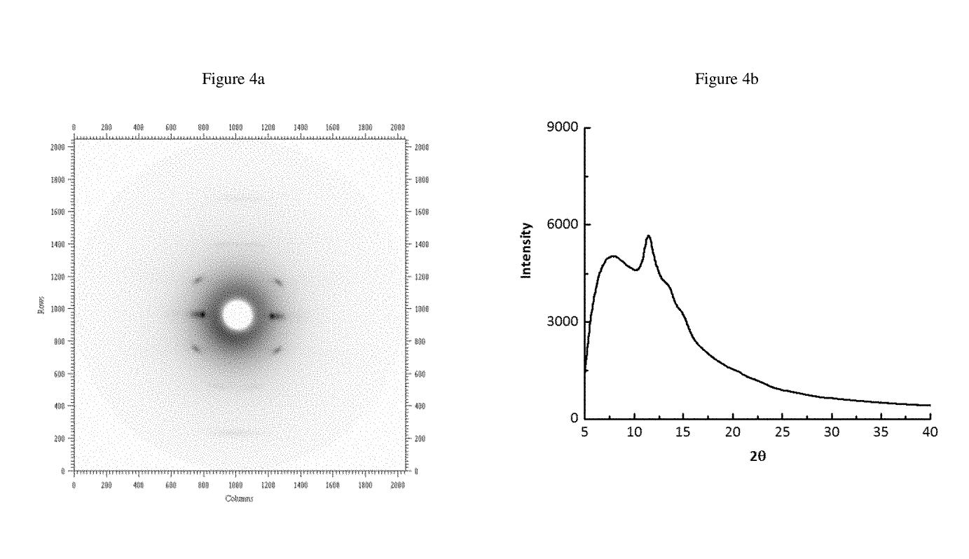

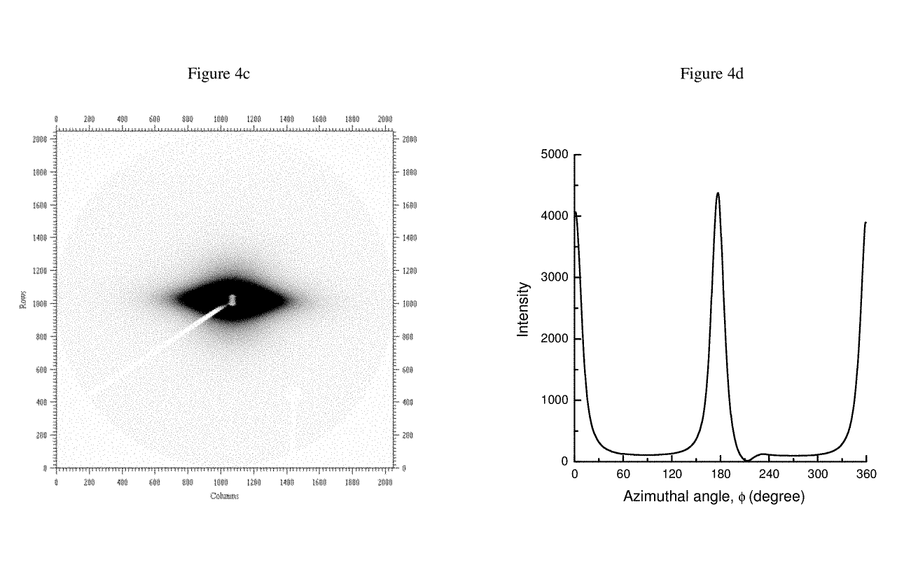

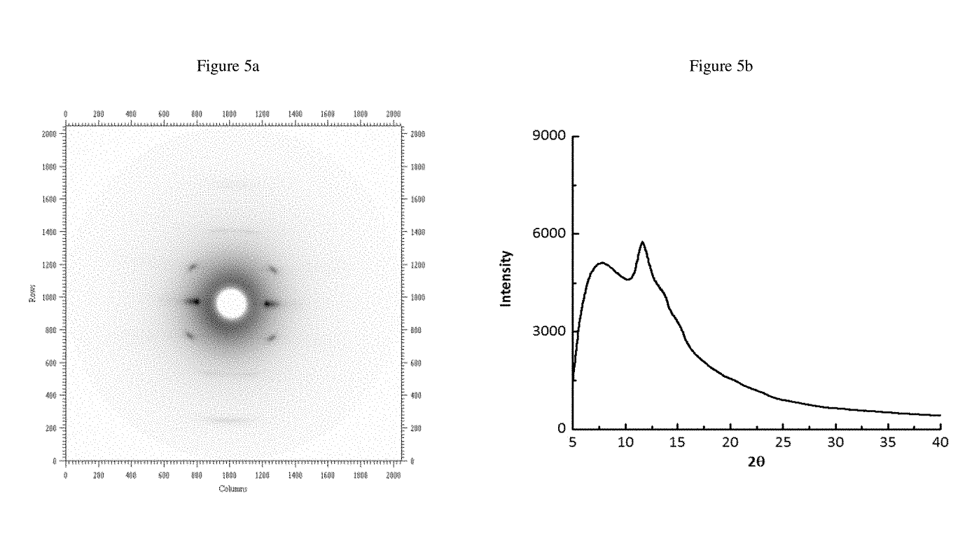

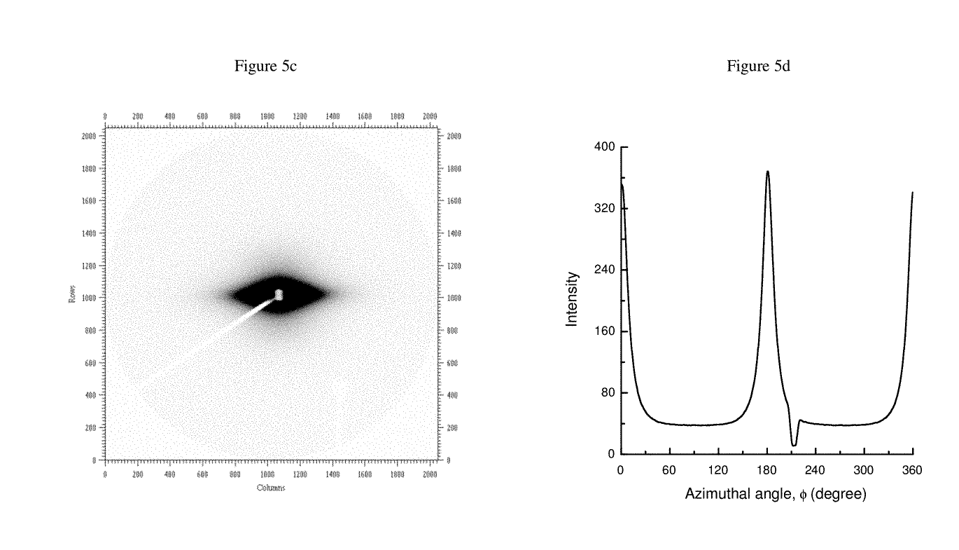

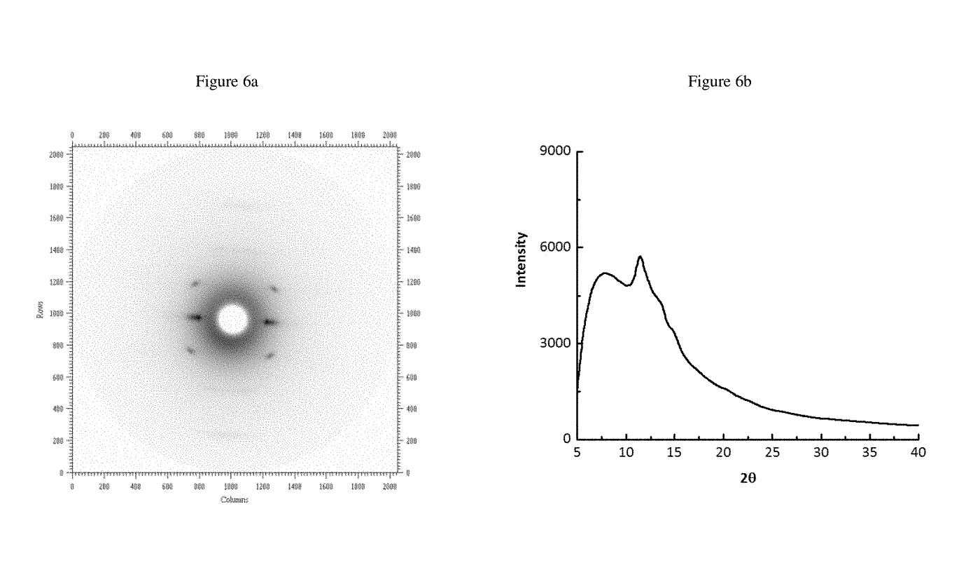

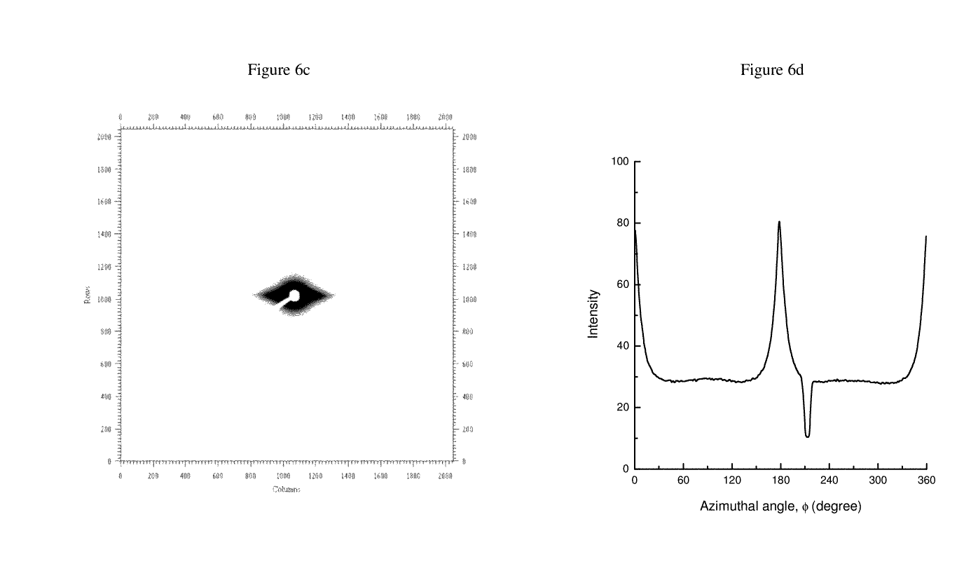

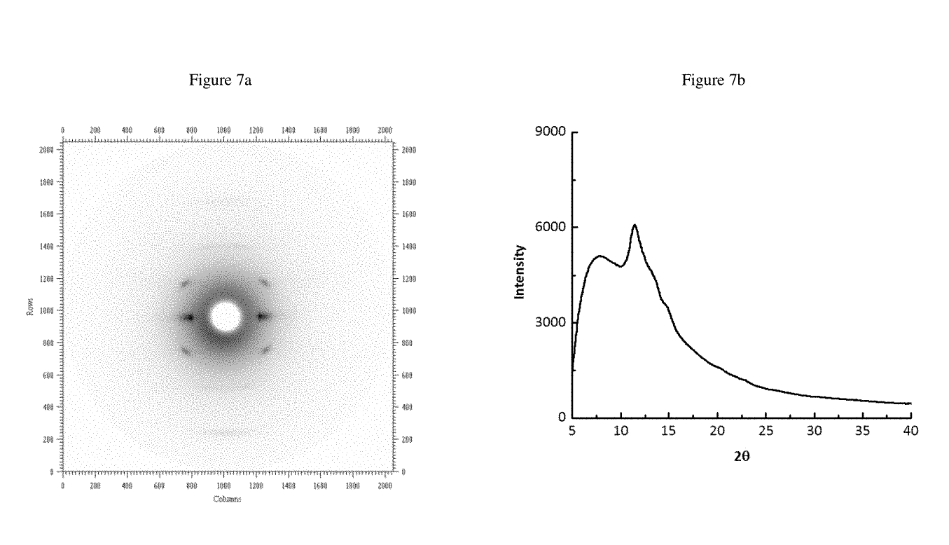

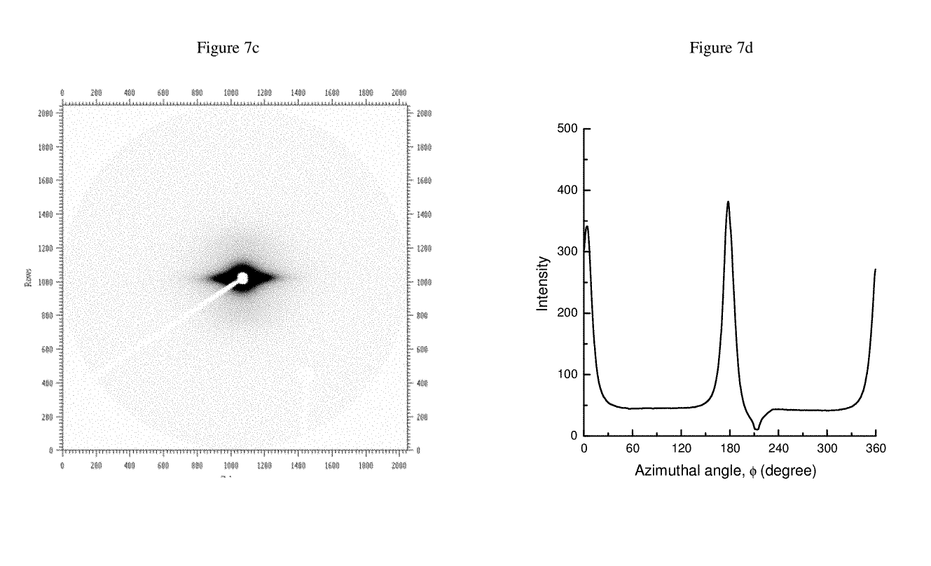

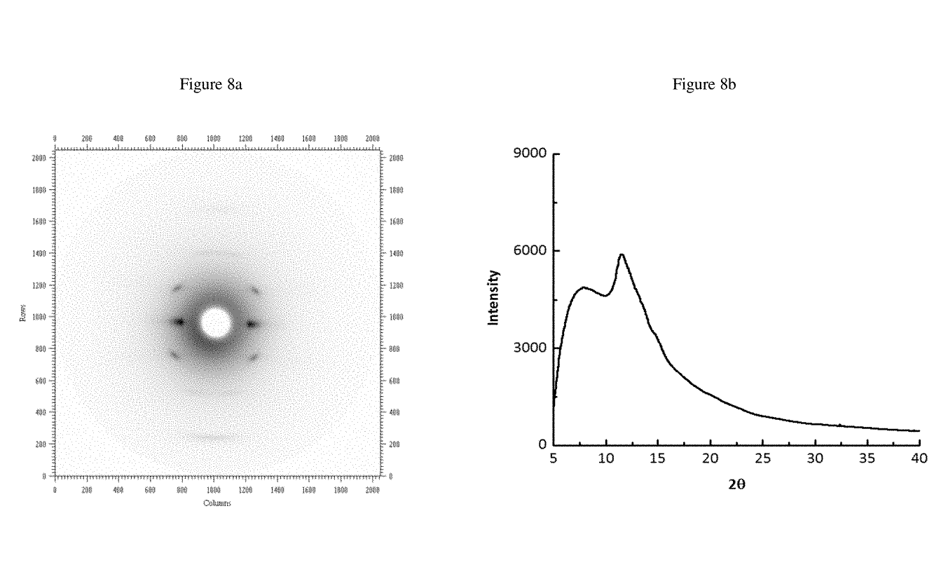

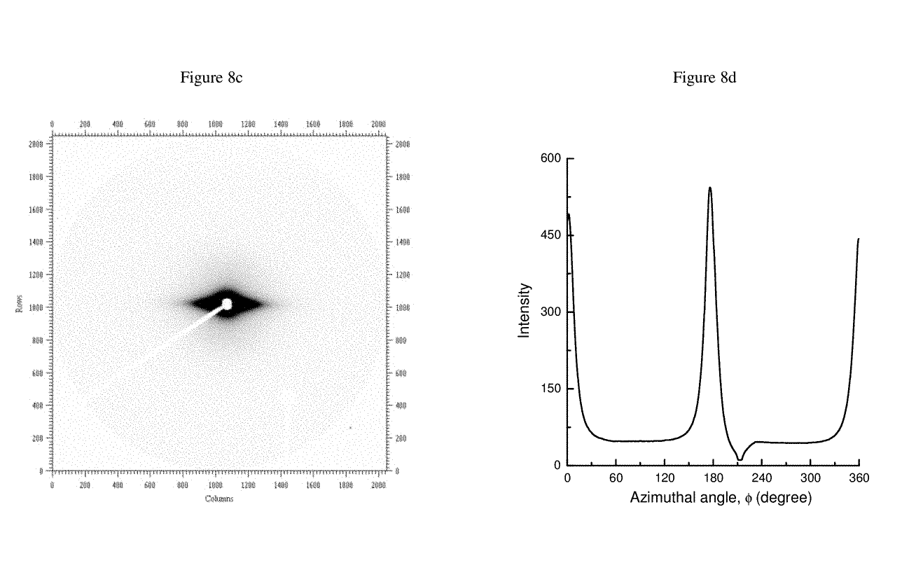

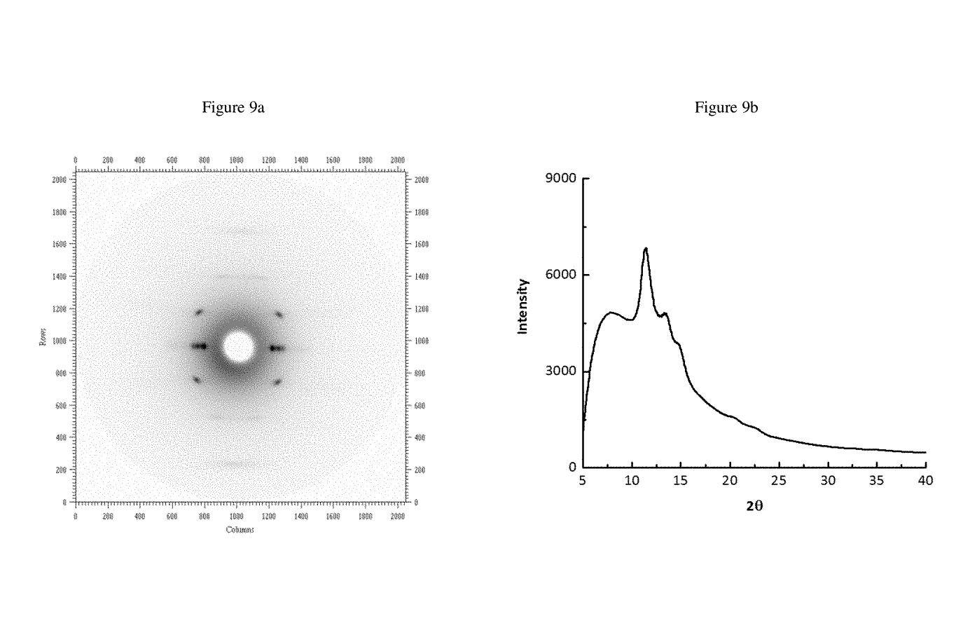

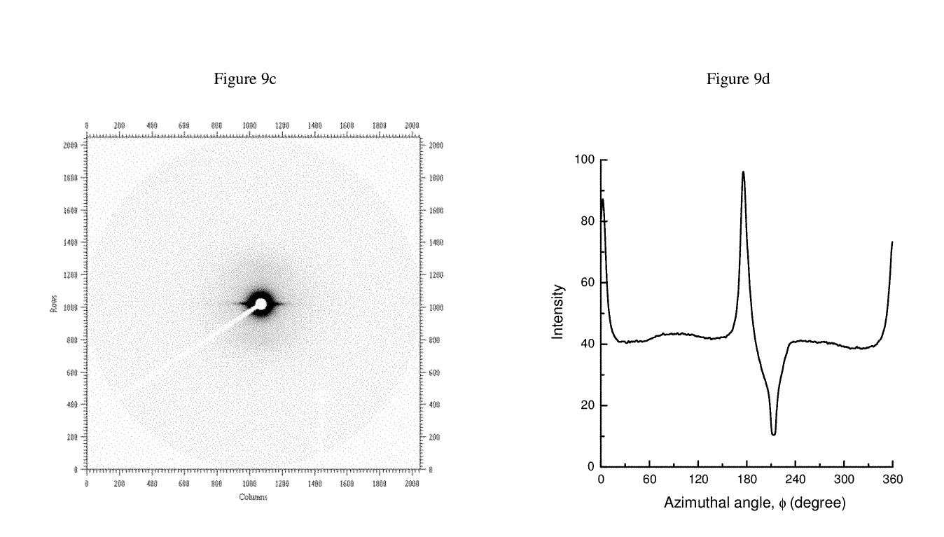

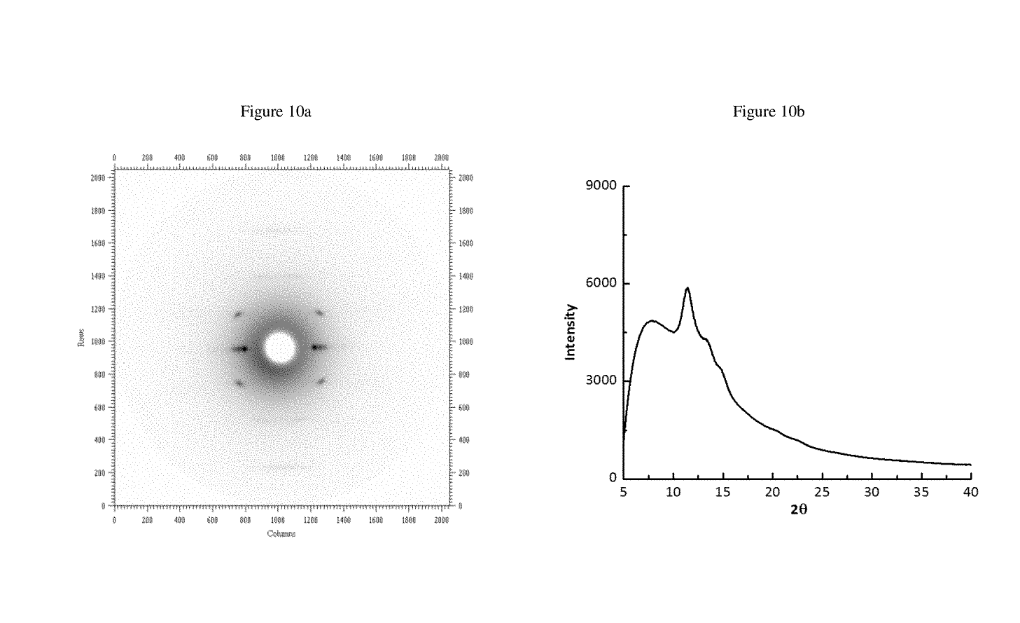

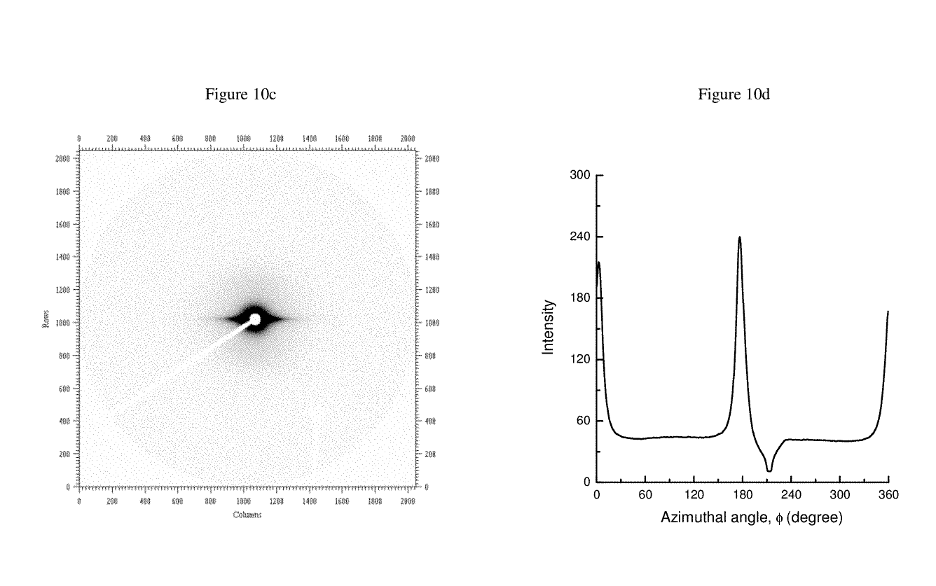

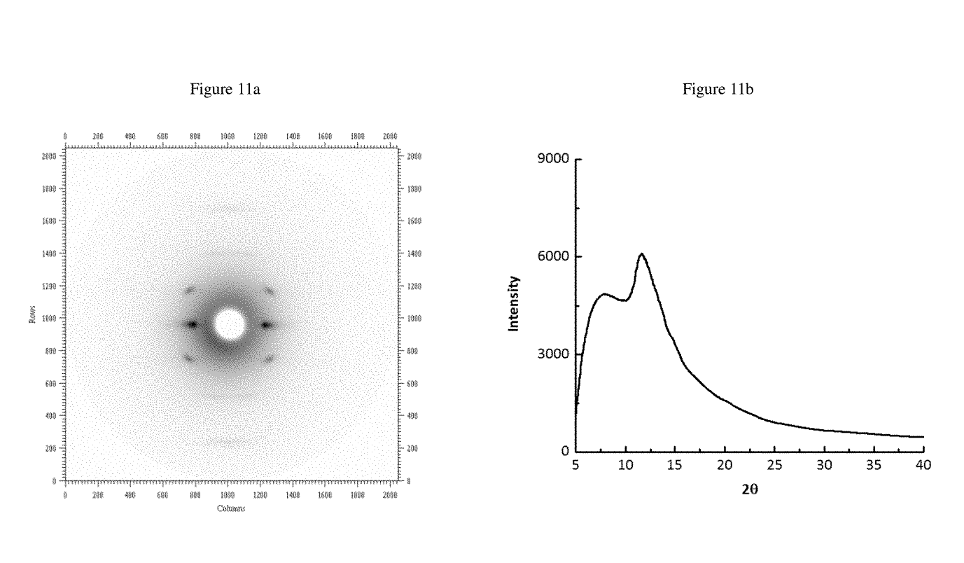

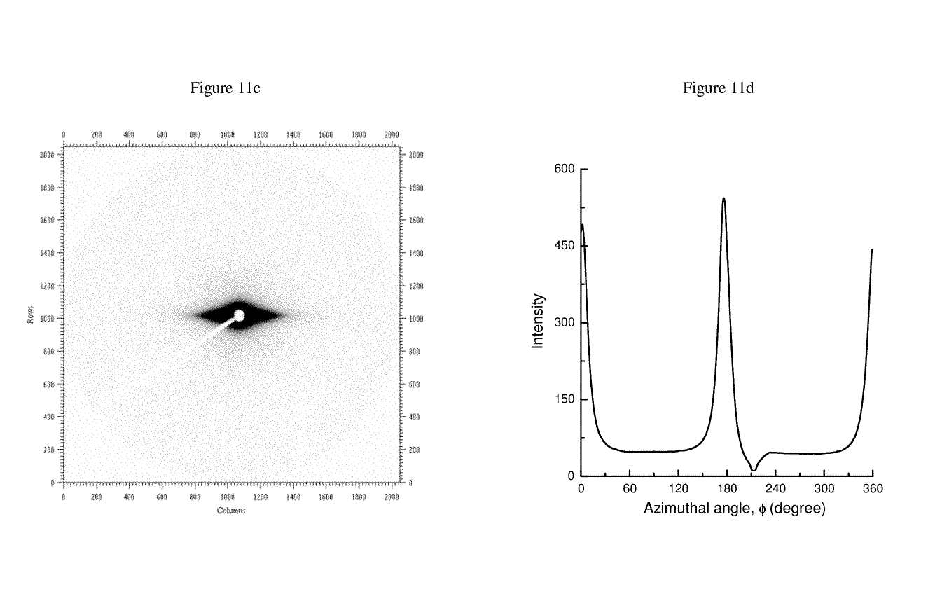

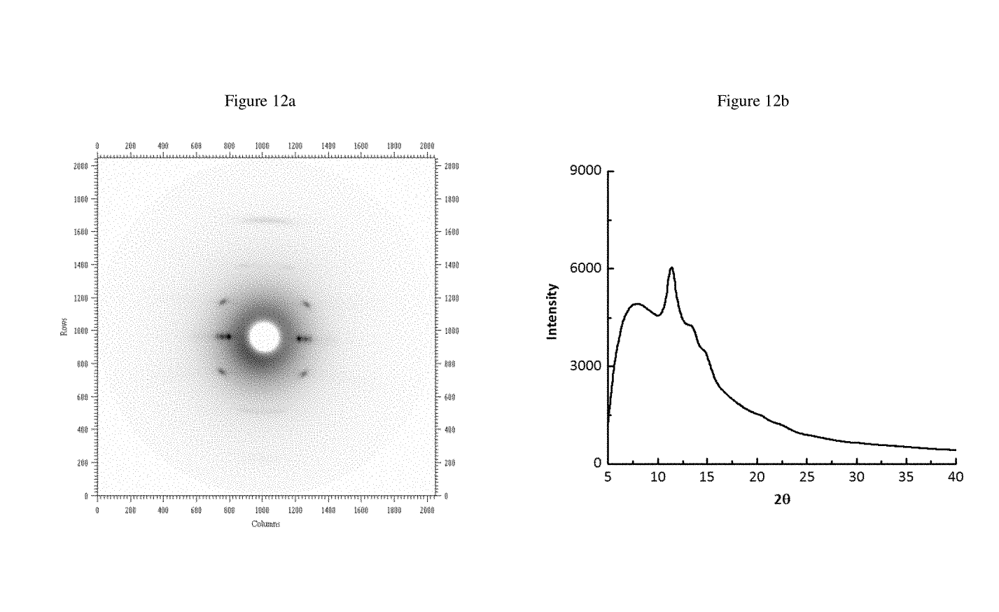

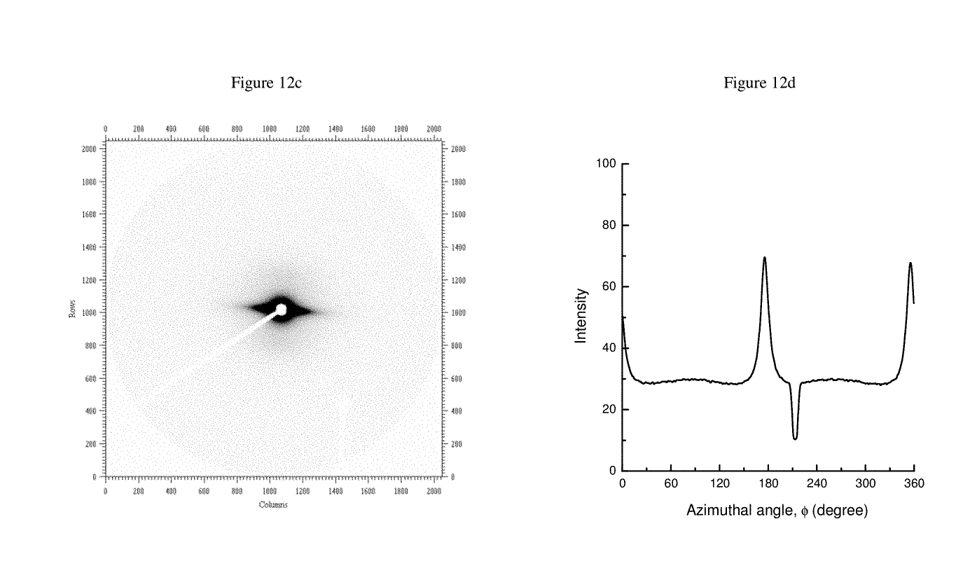

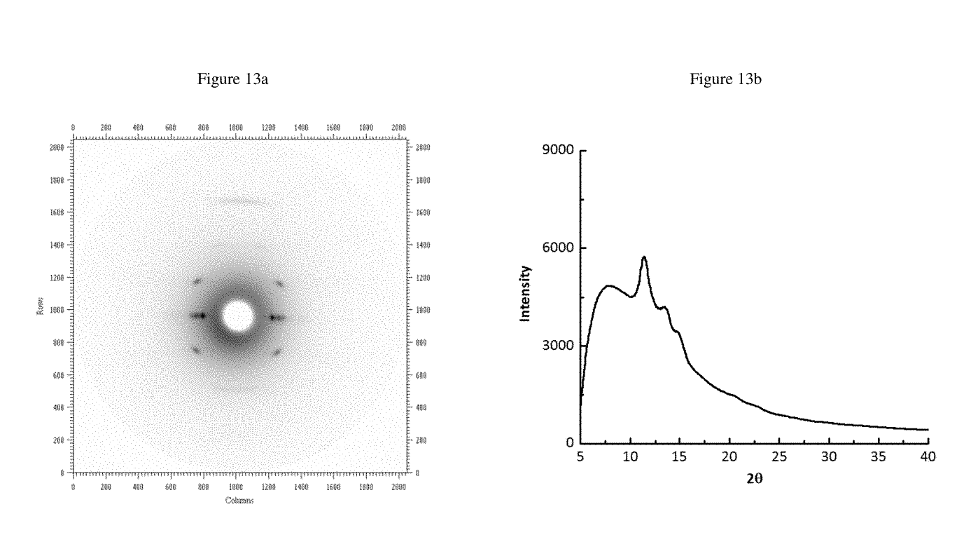

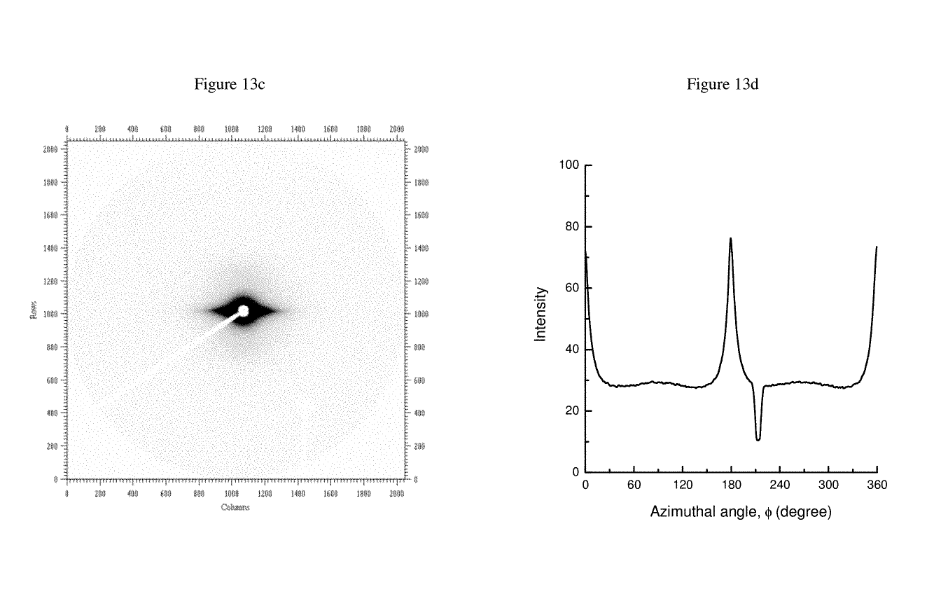

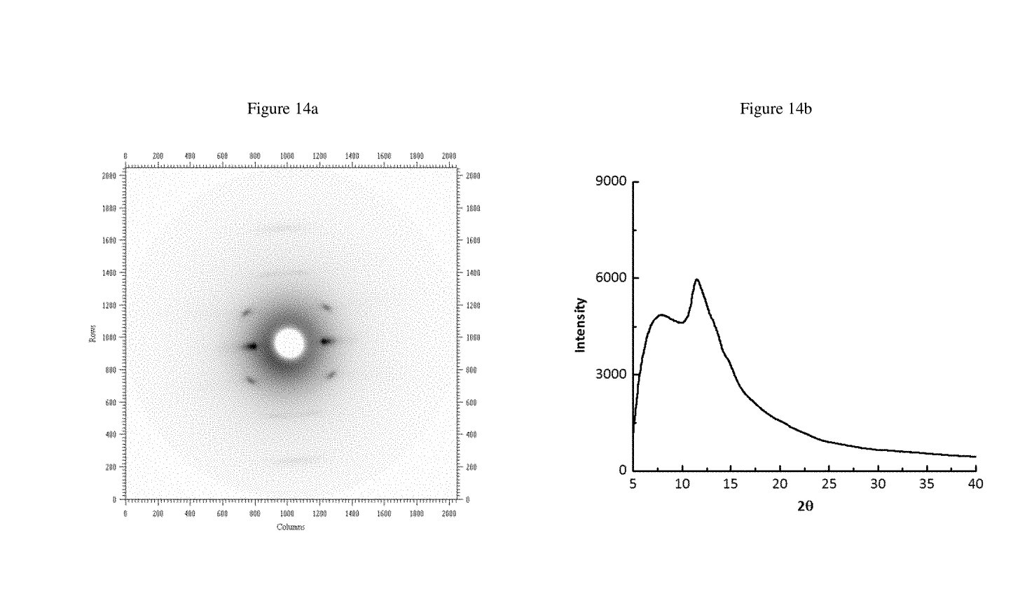

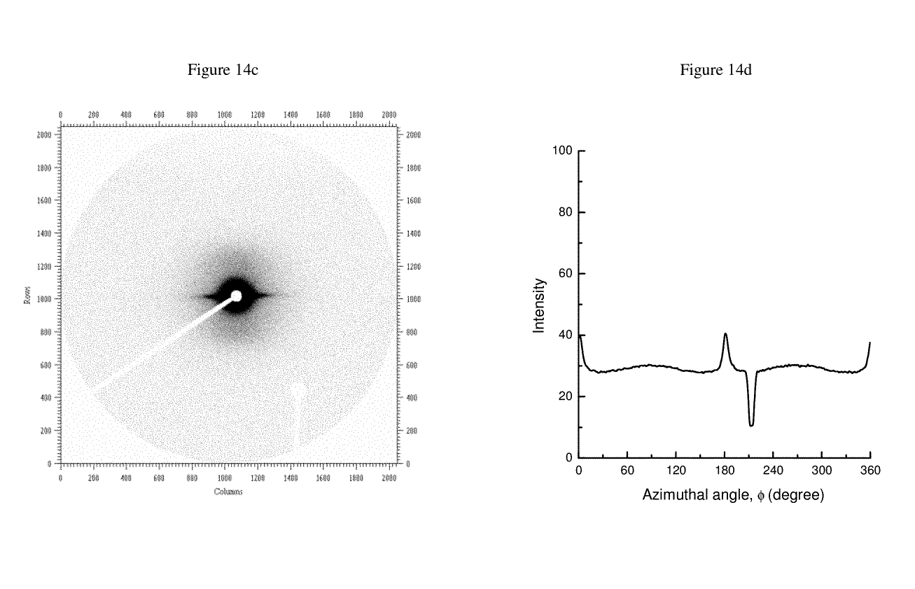

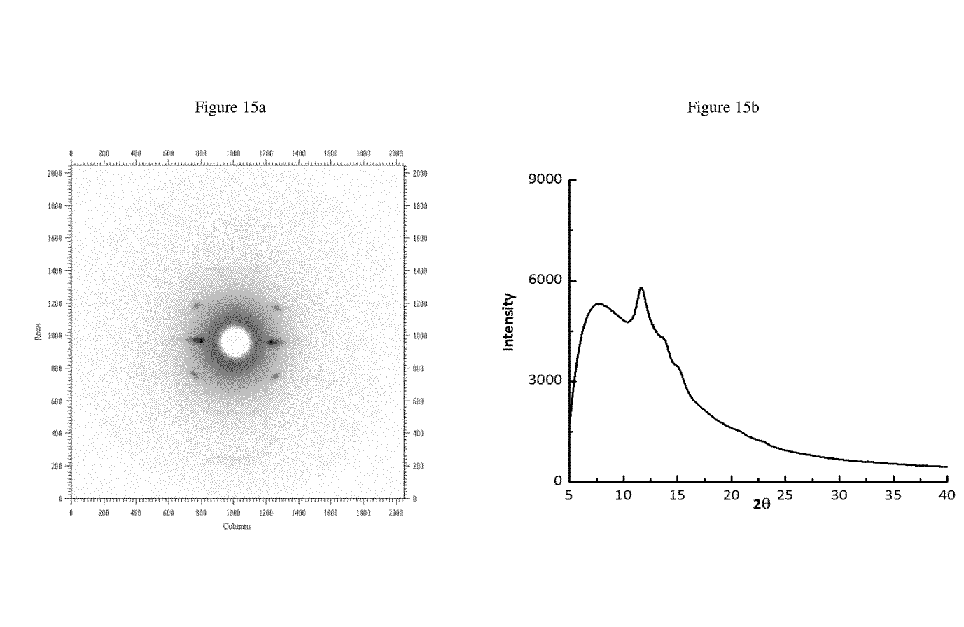

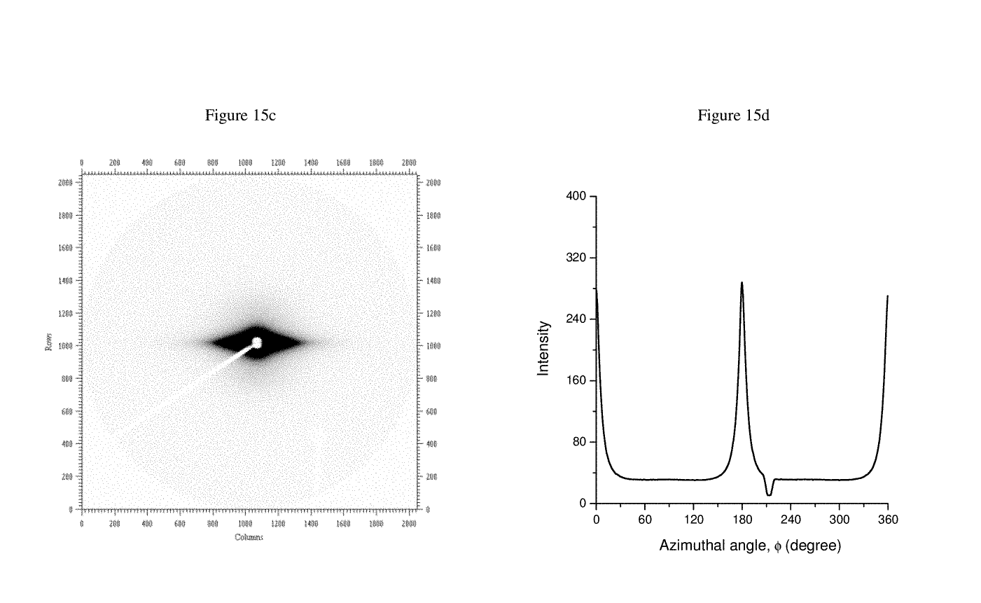

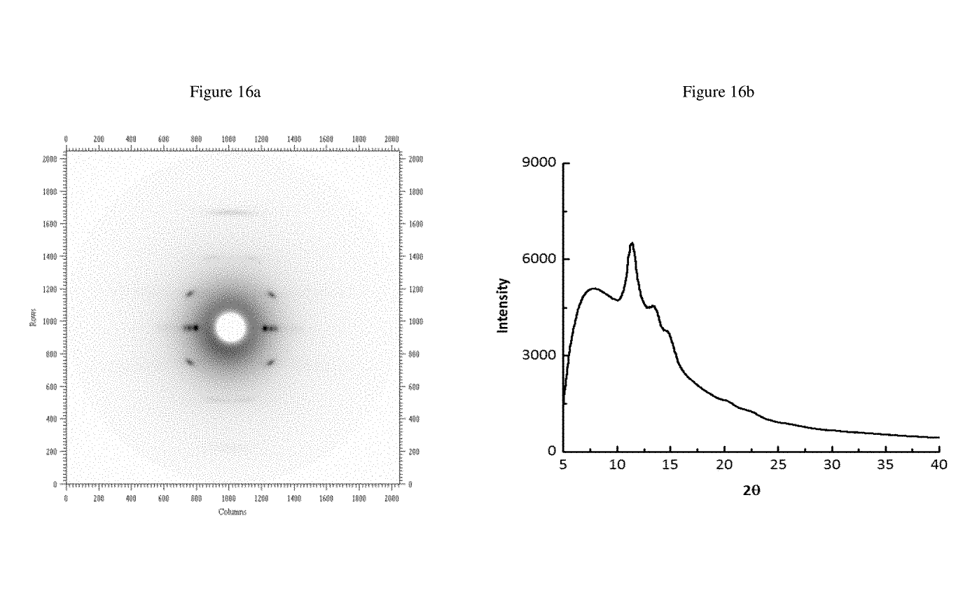

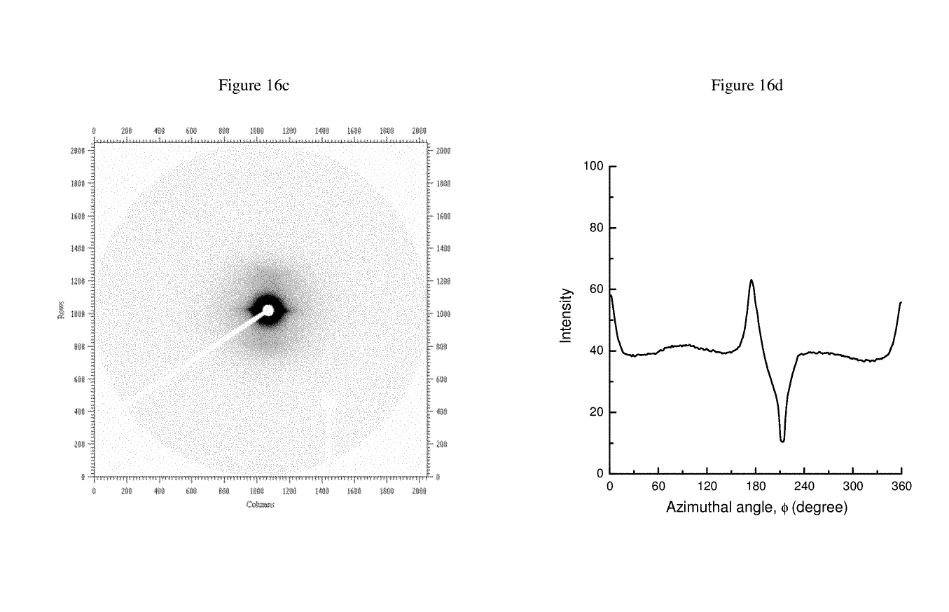

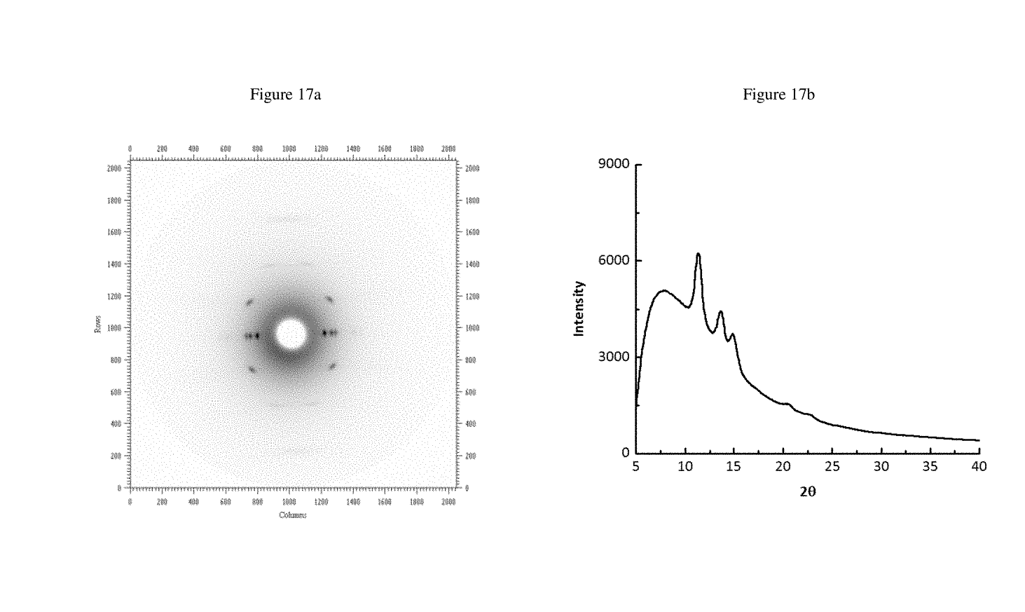

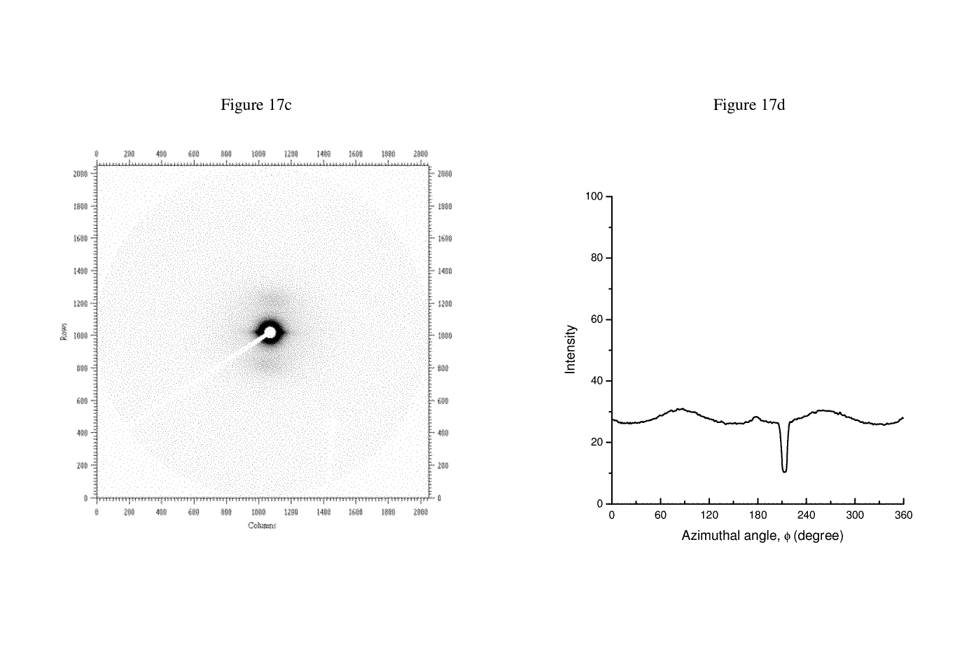

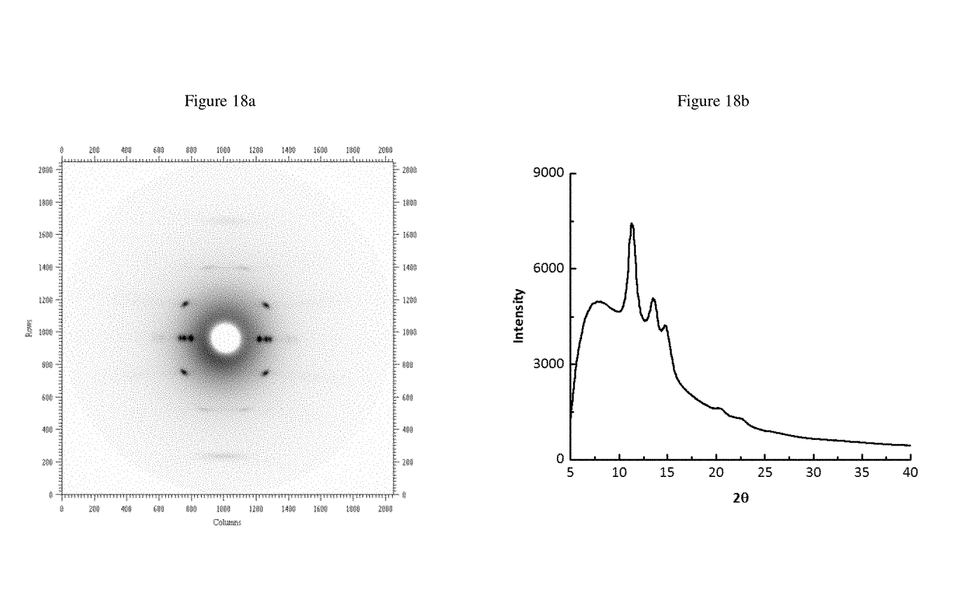

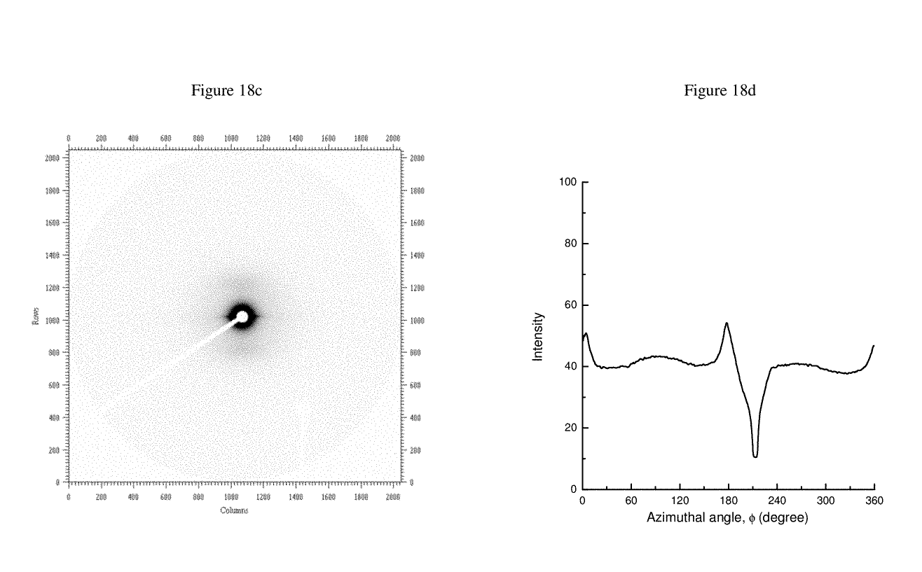

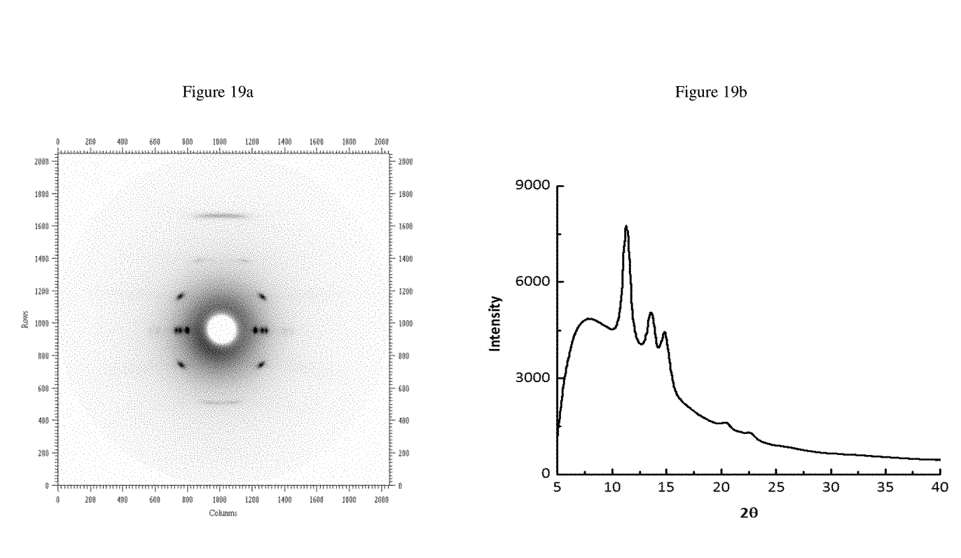

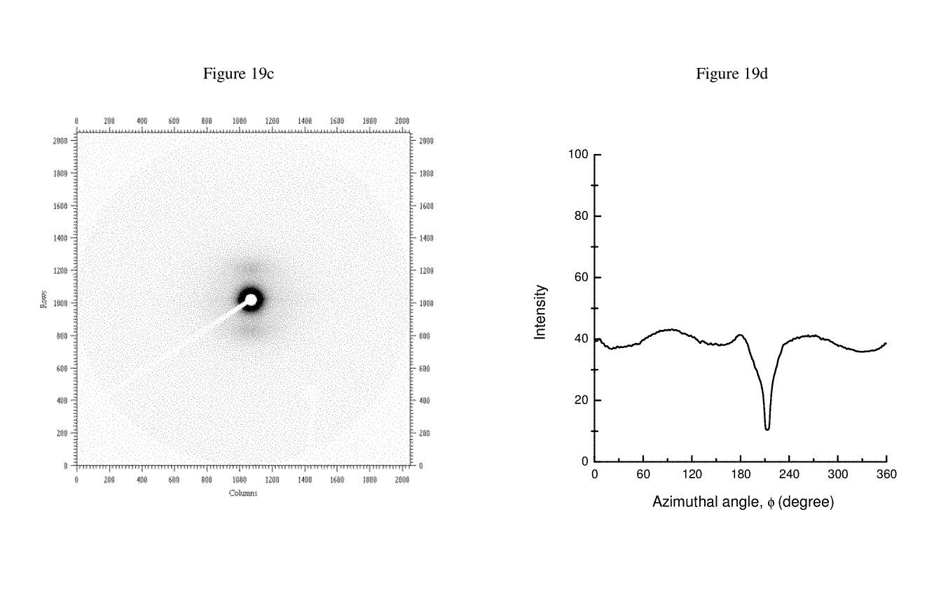

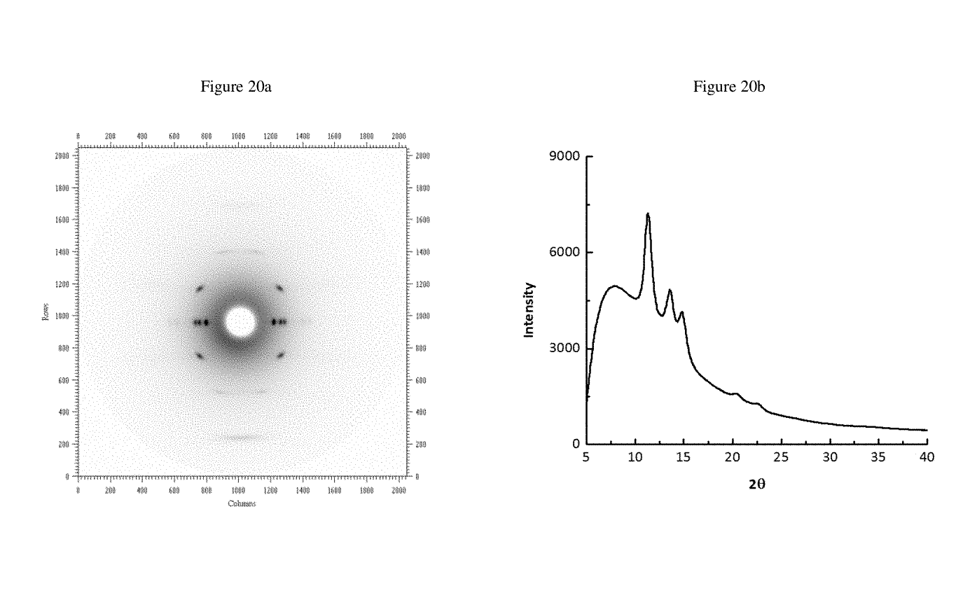

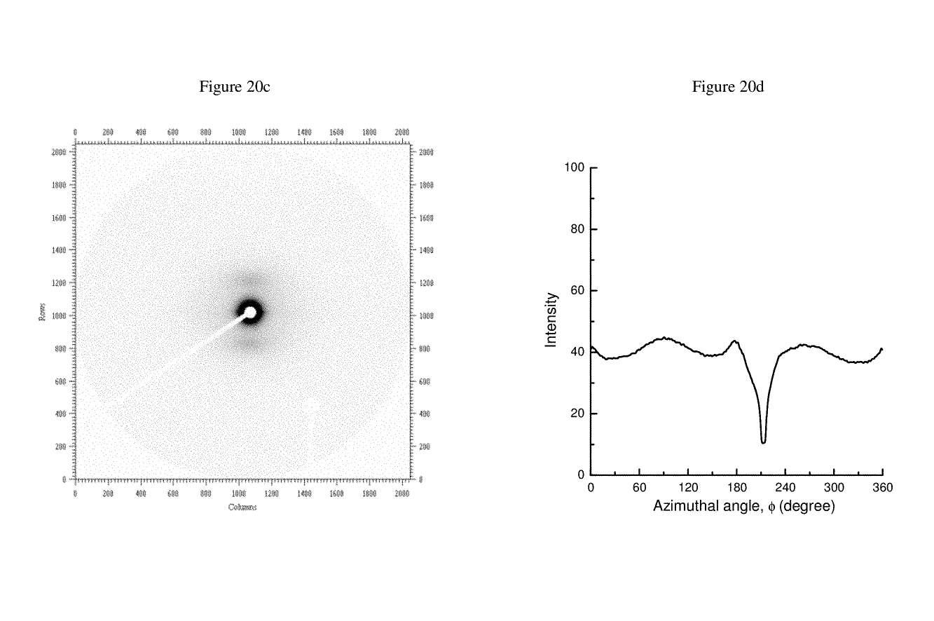

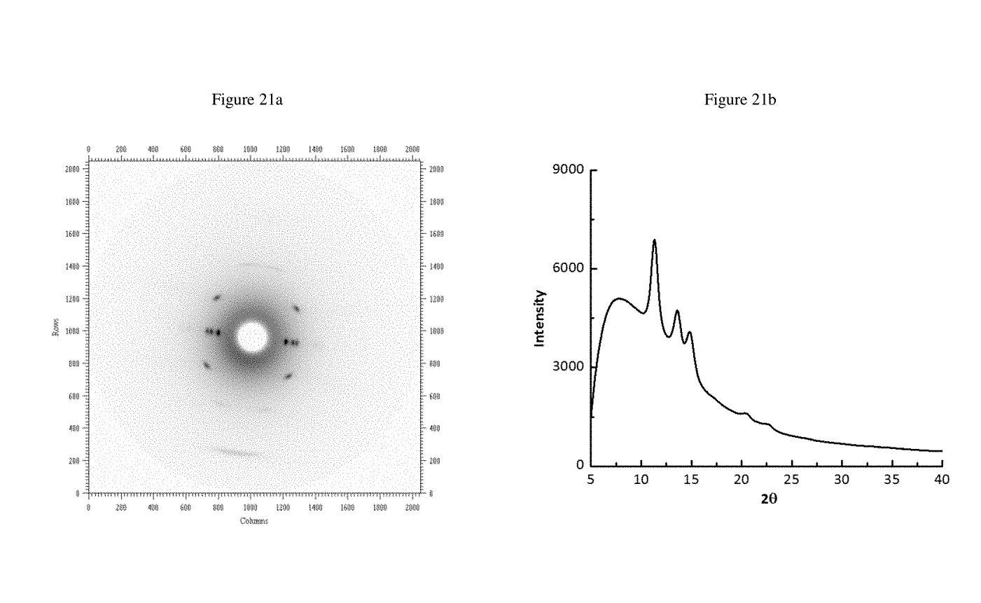

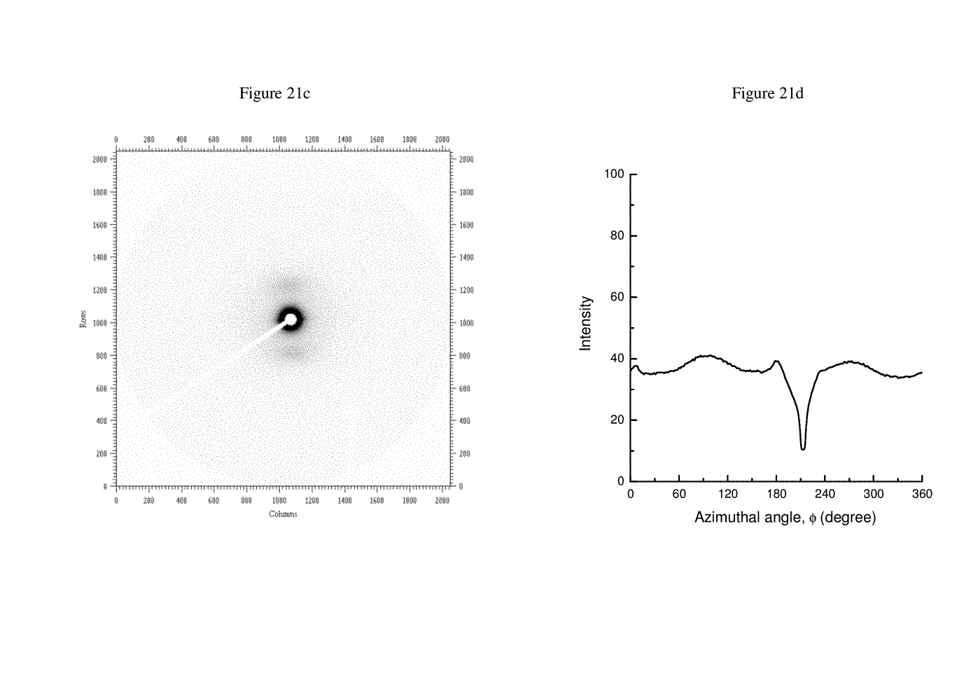

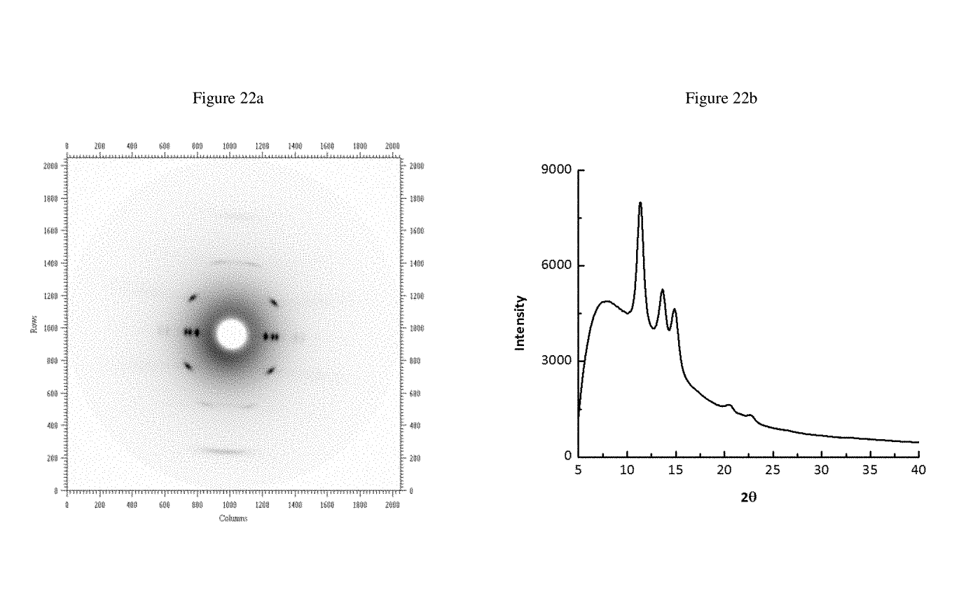

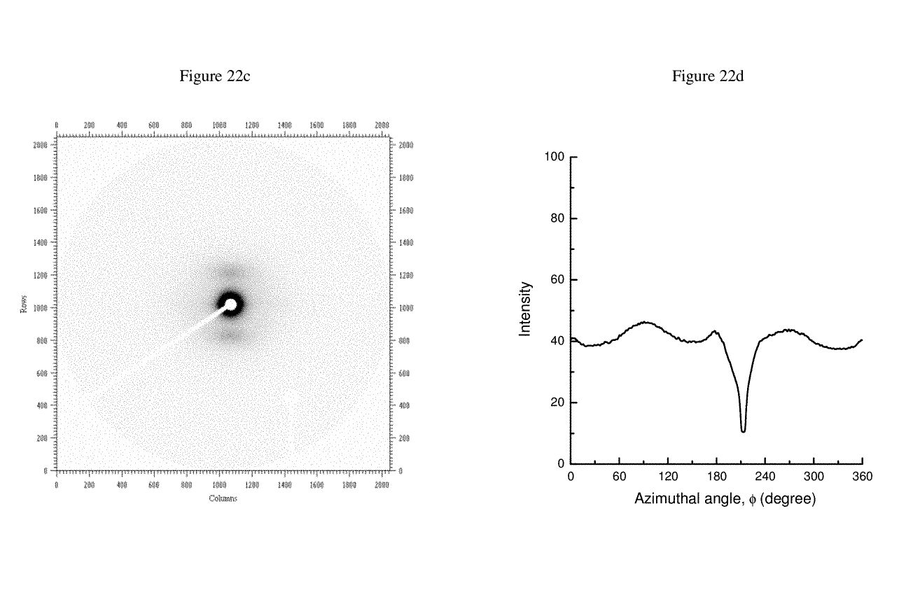

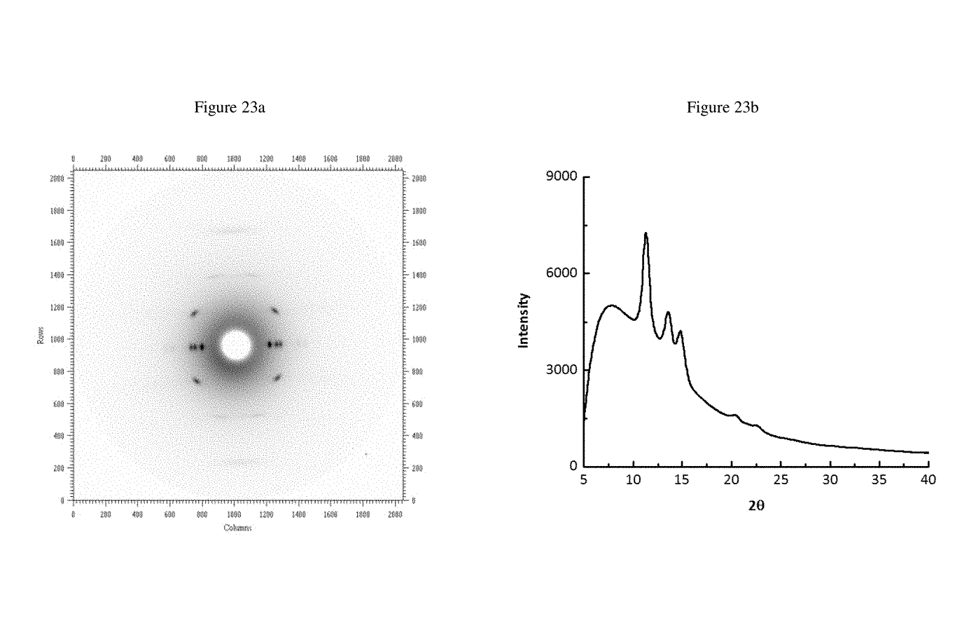

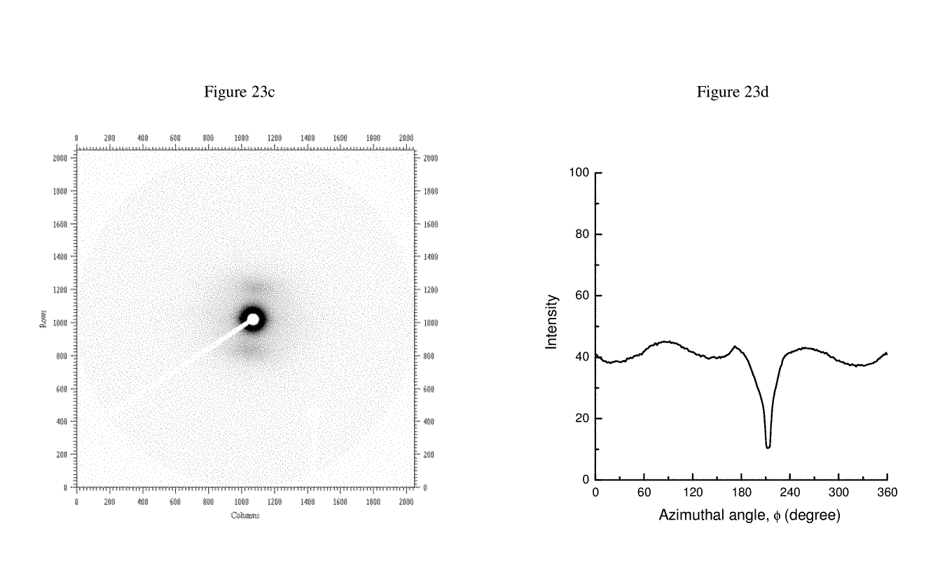

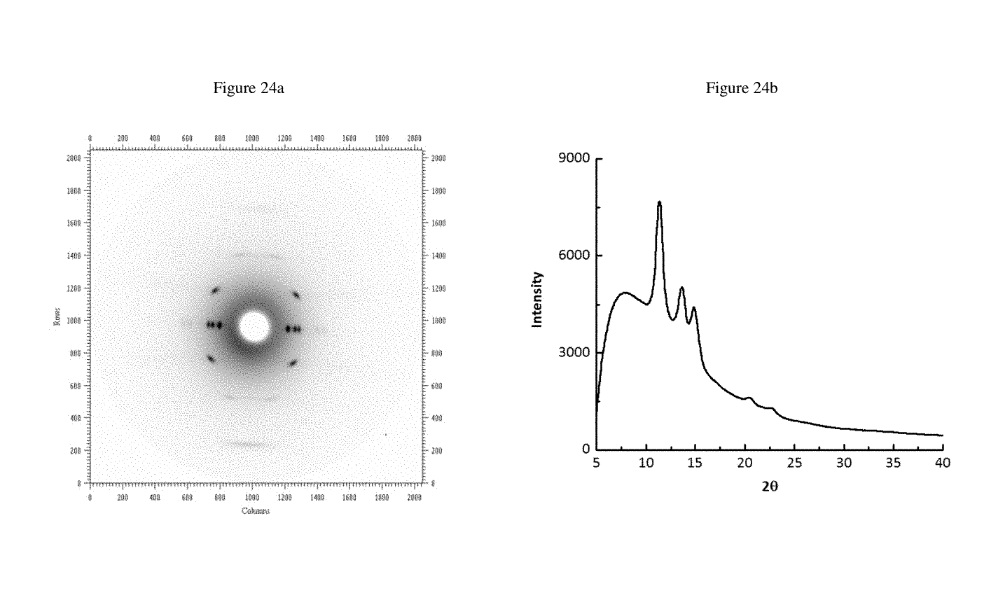

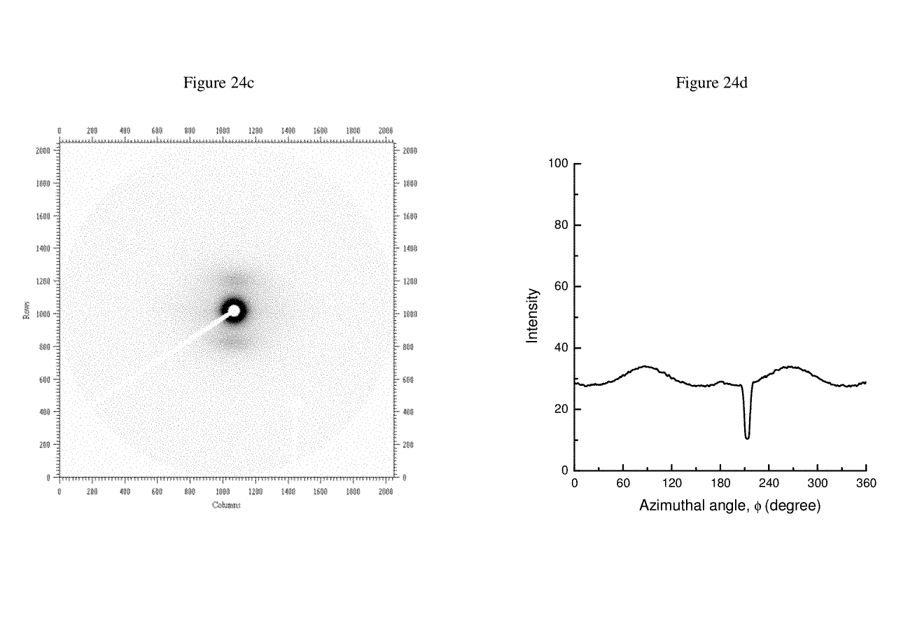

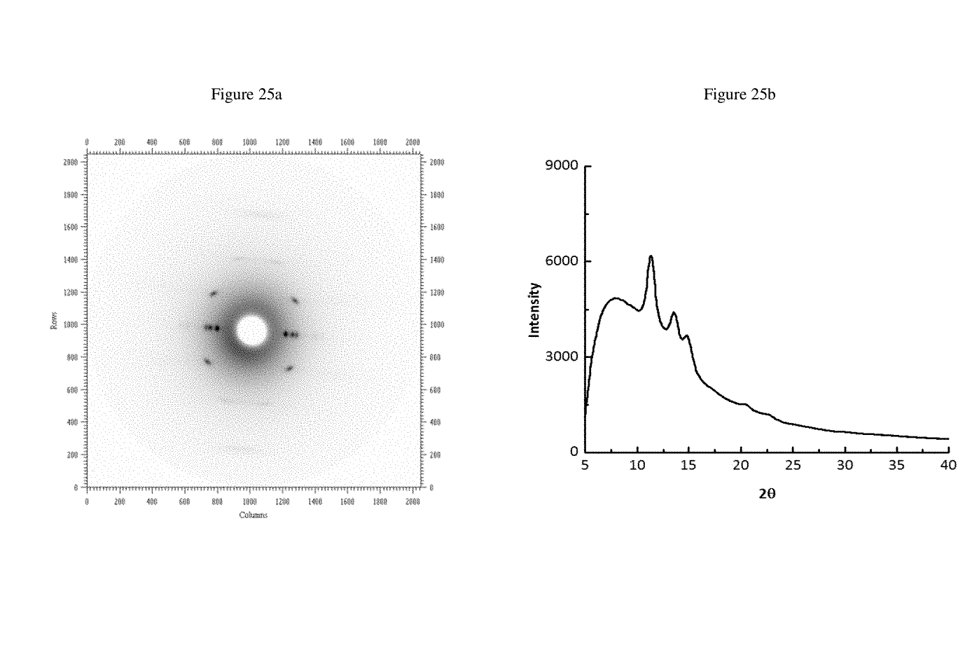

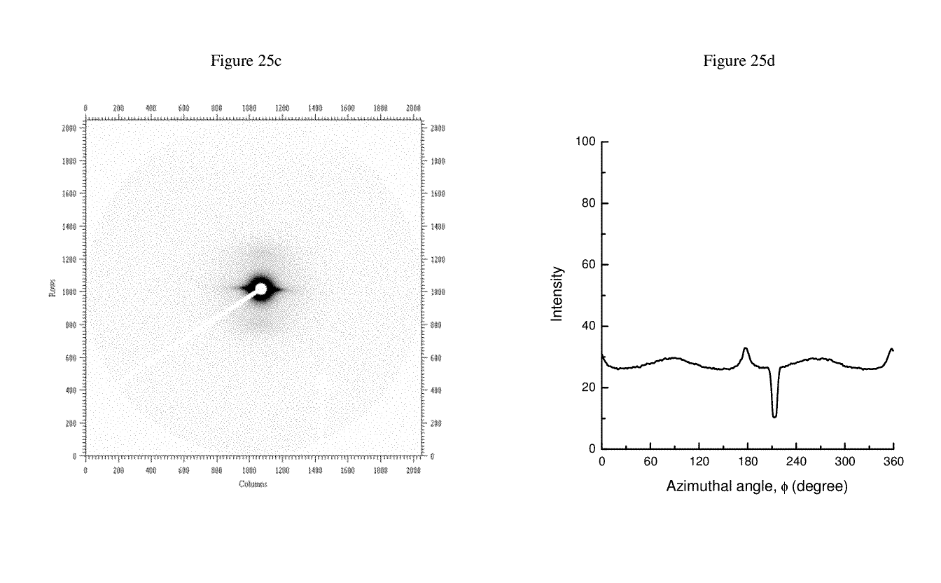

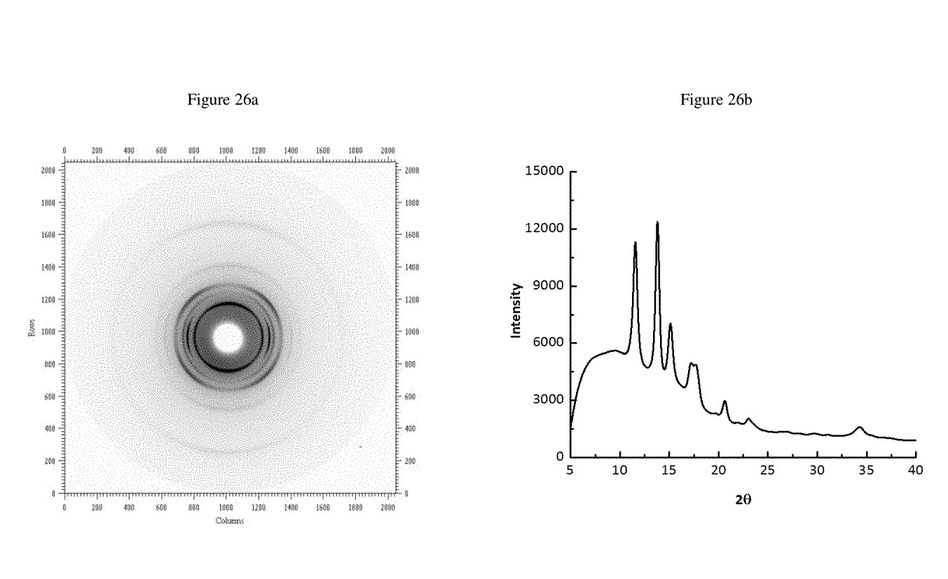

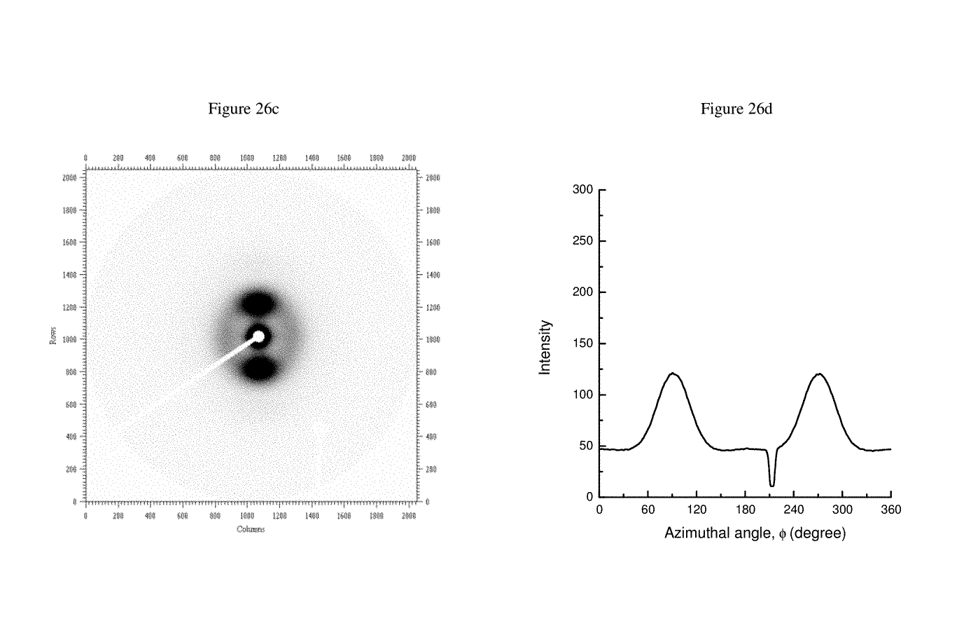

The 2D scattering images of SAXS are plotted and analyzed with Fit2D software from the European Synchrotron Radiation Facility (ESRF). A typical 2D SAXS pattern of non-oriented PP at 23° C. (of control Example 25) is show in FIG. 26c and its corresponding azimuthal intensity profile in FIG. 26d. Details of the film are provided in Example 25 (per the Table of FIGS. 1a and 1b). Generally, there are two categories of SAXS patterns for the oriented PP film. One category is a pattern having an increased scattering intensity perpendicular to the MD, i.e., an equatorial streak, as shown in FIGS. 2c-16c (of Examples 1-15), and its corresponding azimuthal intensity profile with high scattering intensity at azimuthal angle of 0 and 180 degree as shown in FIGS. 2d-16d, respectively (Examples 1-15). The other category is with an oriented scattering intensity in the MD, i.e. meridian maxima, as in FIGS. 17c-25c (Examples 16-24),c, and its corresponding azimuthal intensity profile with high scattering intensity at azimuthal angle of 90 and 270 degree as in FIGS. 17d-25d (Examples 16-24).

### EXAMPLES

The table of FIGS. 1a and 1b provide the details of various monolayer films, including film formulations, film making conditions, and analytical data. The films of examples 1-15 are most preferred. Comparative films of examples 16-24 are outside the scope of the present invention. Lastly, the films of examples 25-27 are controls. The controls are not stretched (and thus have both an elongation percentage and rate of extension of zero).

There are three different film formulations in the examples. Briefly, a first film formulation contains 5 percent of a high viscosity silicone (“HV” silicone type) by weight of the monolayer film and 95% of a random copolymer polypropylene, F280M from Sinopec (“Random” PP type), by weight of the monolayer film. Second film formulation contains the same 5 percent of a high viscosity silicone (“HV” silicone type) by weight of the monolayer film, but 95% of homopolymer polypropylene, PPH-F03D from Sinopec (“Homo” PP type), by weight of the monolayer film. Both of these film formulations use the same HV silicone type, namely MB50-001 from Dow Corning as a silicone masterbatch. The MB50-001 masterbatch is reported to have a MFR (at 230° C./2.16 Kg) of 12 g/10 min. The third film formulation contains 2.5 percent of a low viscosity silicone (“LV” silicone type) by weight of the monolayer film and 97.5% of homopolymer polypropylene, PPH-F03D from Sinopec (“Homo” PP type), by weight of the monolayer film. The LV silicone type, more specifically, is a low viscosity silicone oil having a 1,000 cSt viscosity from Dow Corning.

All film examples (save controls) are stretched in the machine direction (MD) on an INSTRON tensile tester (laboratory scale) equipped with a temperature chamber. The temperature chamber controls the stretching temperature. The variables that are assessed are the stretching temperature, elongation percentage (to assess the degree of stretching in the MD), and extension speed expressed as mm/min. The variables are reported in the table of FIG. 1a.

The film is cut into a one inch wide specimen and tensile clamp gap is set as 10 mm Upon the specimen becoming stabilized under the subject MD stretching temperature (e.g., 25° C., 40° C., 60° C., or 100° C.), the upper clamp moves upward at an extension speed (e.g., 50 mm/min, 200 mm/min, or 500 mm/min) to stretch the film. The stretch ratio or elongation extension rate is defined as (Final clamp distance−original clamp gap (=10 mm))/original clamp gap (=10 mm). The elongation percentage is fixed, save the controls, at 1500% for all film examples. The controls are not stretched having an elongation percentage of zero percent.

From these three film formulation and aforementioned variables, data is collected on each of the film examples including WAXD related data, specifically crystallinity percentage, crystallite size (Å), WAXD pattern, and WAXD Profile. This data is provided in the table of

FIG. 1a for film examples 1-27. Additional data such as opacity, glossiness, FI, DL are provided in the table of FIG. 1b, also for the same film examples 1-25. The table of FIG. 1b also provides SAXS related data including whether there is the presence of an equatorial streak, SAXS pattern, and SAXS profile, also for the same film examples 1-25. Opacity is assessed per ISO 6504. Glossiness is assessed per ASTM E2539. Flop Index (FI) is assessed per ASTM E2539. And Dynamic Luminosity (“DL”) is assessed as previously described. Film samples have a thickness generally from 47 microns to 56 microns.

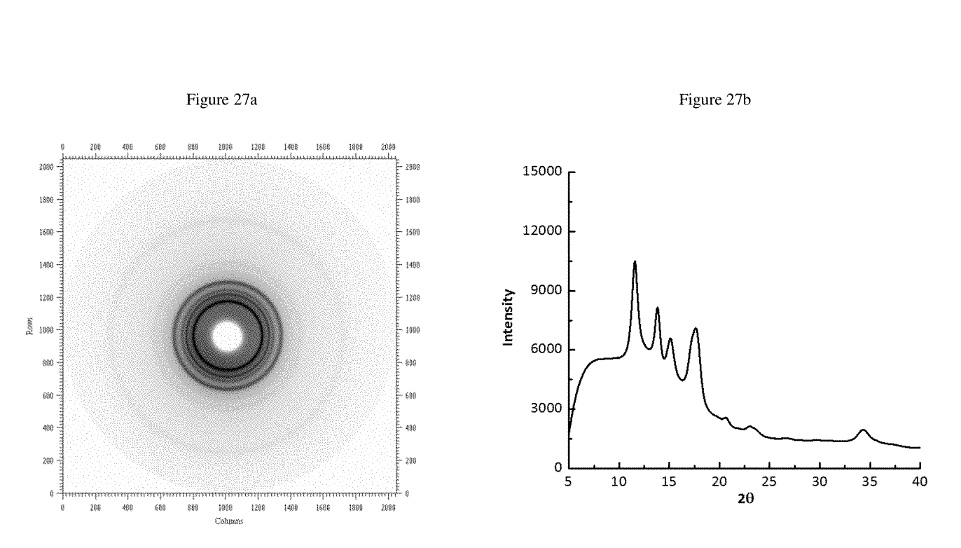

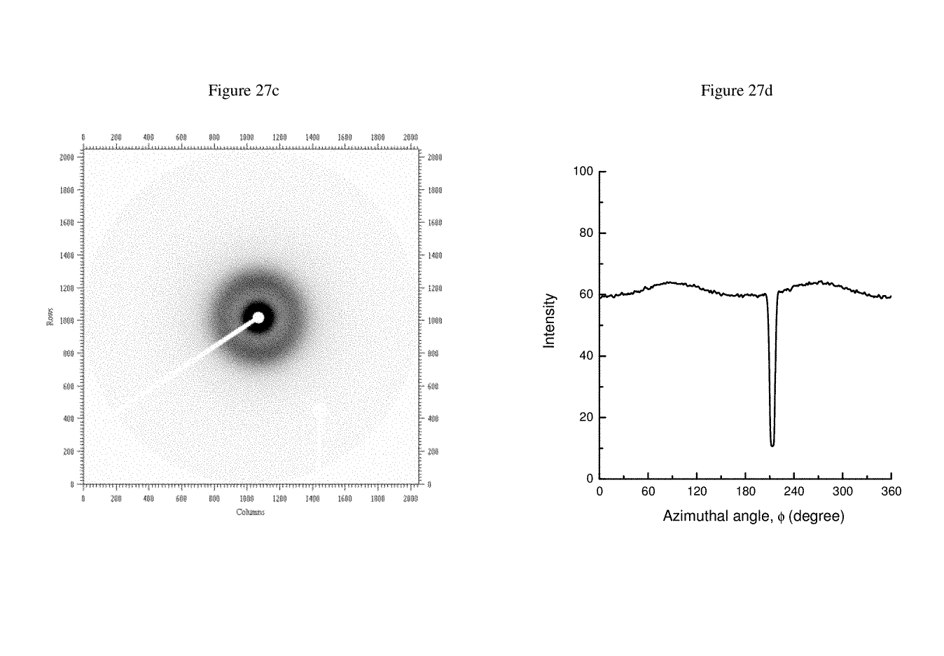

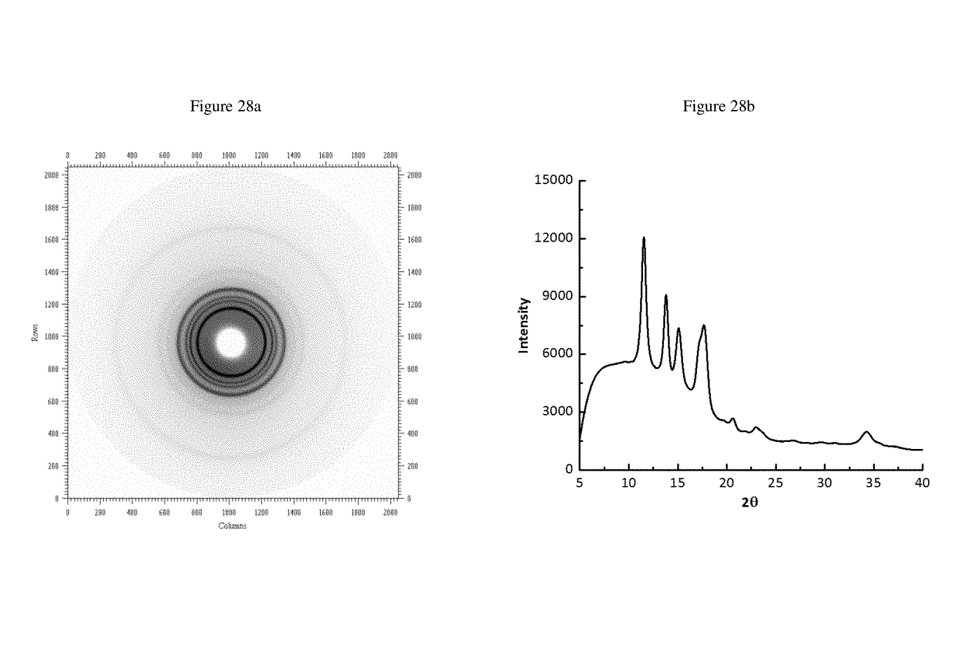

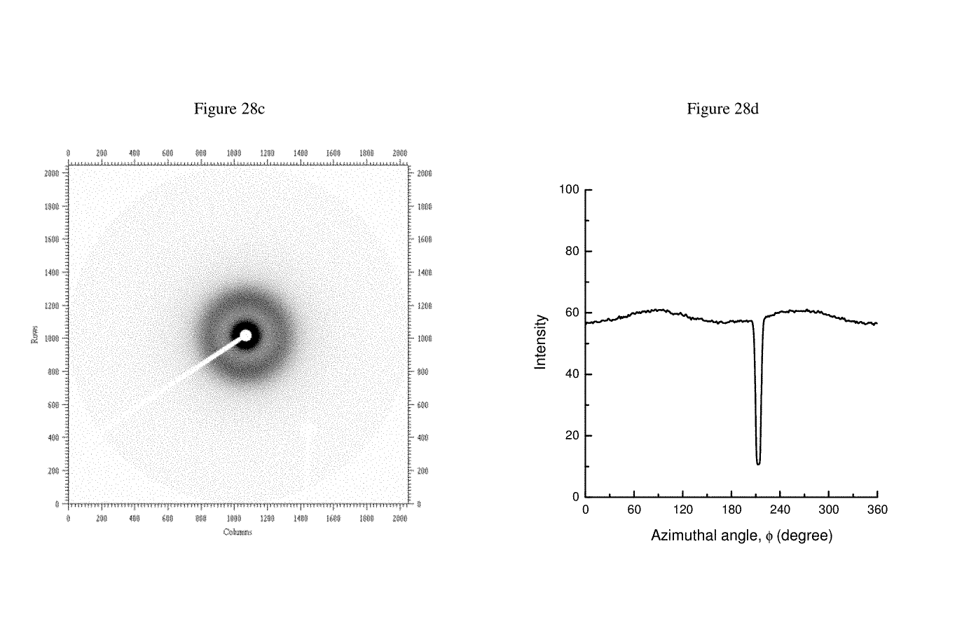

A typical 2D WAXD pattern of samples 1-27 at 23° C. is shown in FIG. 1a 2a-28a, and their circularly averaged WAXD intensity profile is shown in FIG. 2b-28b. Detailed formulation and process conditions of the films are provided in FIG. 1a. In the WAXD profile of the α-crystals of PP, the following reflections are usually expected: (110) at 20=11.6°, (040) at 13.8°, (130) at 15.1°, (111) at 17.3°, and (−131) at 17.6°. No additional diffraction peak can be observed in FIGS. 2b to 28b, suggesting the PP crystals in the film are all in the α form and the current shear process could not change the crystalline form in PP film. From the WAXD profile, the peak position, peak height, peak width, and integrated intensity (peak area) for each crystal reflection and the amorphous background can be extracted. The amorphous background subtraction and peak deconvolution procedures are carried out using the MDI Jade 6.5 software. The crystalline reflections and the background of WAXD profiles are fit with Lorentzian functions (in the range of 10-20°) with an iterative peak-fit procedure, thus, the height, width, and area of each crystal reflection can be obtained. The percent total crystalline phase in the PP is calculated and listed as in Table 1.

There are two categories of SAXS patterns for the oriented PP film. Many of the preferred films with the desired “gloss” visual effect are with an SAXS pattern showing increased scattering intensity perpendicular to the MD, i.e., an equatorial streak, as shown in FIG. 2c-16c, and its corresponding azimuthal intensity profile with high scattering intensity at azimuthal angle of 0 and 180 degree as shown in FIGS. 2d-16d (Examples 1-15). The non-preferred transparent films are with the meridian maxima pattern as in FIG. 17c-25c, and its corresponding azimuthal intensity profile with high scattering intensity at azimuthal angle of 90 and 270 degree as shown in FIGS. 17d-25d (Example 16-24). The equatorial streak in the SAXS patterns is attributed to the formation of the shish, while the meridian maxima are attributed to the lateral lamellae structure. The contribution of the shish to the crystalline phase is much less than that of lamellae.

In our preferred case, the low temperature stretching process causes a significant deformation of the PP crystals in film. This reduces the crystallinity and crystalline size in the film. This observation, together with the silicone lubrication during stretching, noticeably increases the number of shish structure, which is orderly aligned in the MD and reflects light to increase the film glossiness. Consequently, the recrystallization kinetics can be promoted under a higher stretching temperature, resulting in a well oriented lamellae structure and high crystallinity in PP film, which makes the film transparent.

Referring to Table 1, among the best performing films including Examples 1-15, have a stretching temperature at 25° C. This is true for those film formulations tested. Generally, many of these most preferred films have: a crystallinity percentage from 44% to 70%; presence of an equatorial streak; opacity from 82.6 to 88.9; FI from 6.4 to 77; and DL value from 82 to 99. Preferred films have a stretching temperature at or below 60° C. Generally these preferred films have: a crystallinity percentage from 34% to 93%; presence of an equatorial streak (with only two films having a weak, yet present equatorial streak); opacity from 46.2 to 89.8; FI from 3.3 to 9; and DL value from 50.8 to 96.2.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A film comprising having at least one layer, wherein the at least one layer comprises:
a) 80% to 99%, by weight of the at least one layer, of at least one polypropylene (PP) polymer of a PP component;
b) 1% to 20%, by weight of the at least one layer, of at least one silicone of a silicone component;
c) 0% to 15%, by weight of the at least one layer, of an optional ingredient; and
wherein the at least one layer has a percentage of crystallinity of less than 95% as determined by Wide-Angle X-ray Diffraction (WAXD).

2. The film of claim 1, wherein the at least one layer has a presence of an equatorial streak as determined by Small-Angle X-ray Scattering (SAXS).

3. The film according to any one of the preceding claims, wherein the percentage of crystallinity is from 20% to less than 90%, preferably from 25% to 80%, preferably from 34% to 75%.

4. The film according to any one of the preceding claims, wherein at least one layer has a Flop Index (FI) (per ASTM E2539) greater than 1.6, preferably at or greater than 3.3, more preferably greater than 3.8, yet more preferably greater than 5, yet still more preferably greater than 6, yet still even more preferably greater than 6.4.

5. The film according to any one of the preceding claims, wherein at least one layer has an opacity (per ISO 6504) greater than 10%, preferably greater than 40%, more preferably greater than 50%, yet more preferably greater than 60%, yet still more preferably greater than 70%, yet still more preferably greater than 80%.

6. The film according to any one of the preceding claims, wherein at least one layer has a Dynamic Luminosity (DL) (as described herein) greater than 49, preferably greater than 50, more preferably from greater than 60, yet more preferably greater than 70, yet still more preferably greater than 80.

7. The film according to any one of the preceding claims, wherein the least one PP is a polymer grade selected from the group consisting of homopolymer, random copolymer, impact copolymer, and combinations thereof, preferably the polymer grade is a homopolymer or a random copolymer.

8. The film according to any one of the preceding claims, wherein the at least one layer comprises from 90% to 99%, preferably from 94% to 98.5%, of PP by weight of the at least one layer.

9. The film according to any one of the preceding claims, wherein the at least one layer comprises from 1% to 10%, preferably from 1.5% to 7%, more preferably from 2% to 6%, of the silicone by weight of the least one layer.

10. The film according to any one of the preceding claims, there the thickness of the at least one layer is from 10 microns to 110 microns, preferably from 20 microns to 90 microns, more preferably from 30 microns to 70 microns.

11. The film according to any one of the preceding claims, wherein the least one silicone, is a siloxane fluid, preferably the siloxane fluid is a linear or branched polymer or copolymer, more preferably the siloxane fluid is selected from polydimethylsiloxane homopolymers, copolymers consisting essentially of dimethylsiloxane units and methylphenylsiloxane units, copolymers consisting essentially of diphenylsiloxane units and methylphenylsiloxane units, and combinations thereof.

12. The film according to any one of the preceding claims, wherein the film is substantially free, preferably free, of pearlescent agents and titanium dioxide.

13. The film according to any one of the preceding claims, wherein the film is a monolayer film.

14. A method of making a film according to any one of the preceding claims, comprising the step of stretching at temperature below 70° C., preferably below 60° C., more preferably below 50° C., yet more preferably below 40° C., yet still more preferably below 30° C.

15. The method of claim 12, wherein the uniaxial elongation percentage is at least 200% preferably at least 300%, more preferably at least 400%, preferably at least 500%.
